(19) United States
(12) Patent Application Publication
(10) Pub. No.: US 2026/0289101 A1
(43) Pub. Date: Sep. 24, 2026

(54) SYSTEM

(71) Applicant: SoftBank Group Corp., Tokyo (JP)

(72) Inventor: Naoko NAKANISHI, Tokyo (JP)

(73) Assignee: SoftBank Group Corp., Tokyo (JP)

(21) Appl. No.: 19/567,379

(22) Filed: Mar. 16, 2026

(30) Foreign Application Priority Data
Mar. 19, 2025 (JP) 2025-045075

(51) Int. Cl. G06F 40/186; G06F 40/106; G06N 3/0475; G06V 10/56; G06V 10/82; G06V 20/00

(52) U.S. Cl. CPC G06F 40/186; G06F 40/106; G06N 3/0475; G06V 10/56; G06V 10/82; G06V 20/35

(57) ABSTRACT

A system includes a processor configured to analyze user-input text data and classify information by assigning numerical values representing importance and relevance. The processor organizes the classified information into a class newsletter format and generates a prompt instructing a generative AI model to produce newsletter body text. The processor further generates a prompt for creating a visually understandable layout based on the body text and applies a template combining text and images. Image recognition is used to analyze candidate images and generate prompts for selecting appropriate images based on newsletter content and visual balance. The processor estimates a user emotional state based on at least one of input history, browsing history, or real-time facial expression recognition, adjusts newsletter expressions accordingly, and outputs optimized newsletter content in printed or digital format.

### CROSS-REFERENCE TO RELATED APPLICATION

This application is based on and claims priority under 35 USC 119 from Japanese Patent Application No. 2025-045075 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for creating class newsletters require teachers or other users to manually draft text, arrange information according to layout constraints, select and place suitable images, and adjust expressions based on the expected readers. Such operations are burdensome and time-consuming, especially for users who are unfamiliar with information processing devices or digital content creation tools. In particular, there are several problems: (i) important information may not be clearly distinguished from less important information, resulting in newsletters that are difficult for parents or guardians to understand; (ii) the layout and balance between text and images often depend on the user's individual skill, leading to inconsistent visual quality; (iii) appropriate images are not always selected, and the visual balance of the newsletter can be poor; and (iv) the content and tone of the newsletter are not optimized according to the emotional state of the user or the interests of the recipients. As a result, class newsletters can become difficult to produce, may fail to engage recipients, and may not effectively communicate the intended information.

### SUMMARY

In order to solve the foregoing problems, the invention provides a system comprising a processor configured to perform a series of processing steps based on user input and interaction with one or more generative AI models. The processor analyzes text data input by a user and classifies the information by assigning numerical values representing importance and relevance, and then organizes the classified information so as to conform to a class newsletter format. The processor creates a prompt for instructing a generative AI model to generate a body text of the class newsletter, inputs the prompt to the generative AI model, and receives and uses the generated body text. The processor further generates a prompt for instructing creation of a visually understandable layout based on the body text, applies a layout template, and creates a visual layout that combines textual information and image information. The processor analyzes contents of images to be inserted into the class newsletter by using image recognition techniques, generates a prompt for instructing selection of appropriate images, and inserts images into the class newsletter in consideration of the contents of the newsletter and visual balance. In addition, the processor estimates an emotional state of the user based on at least one of the user's input history, browsing history, and real-time facial expression recognition, generates a prompt for instructing optimization of expressions according to the emotional state, and adjusts the contents of the class newsletter accordingly. The processor also generates a prompt for instructing output of the optimized newsletter contents as a printed format or digital format and creates final output data. By integrating these functions, the system reduces the burden on users who are not proficient with information processing devices, ensures that important information is clearly communicated, and automatically produces visually balanced and reader-engaging class newsletters.

The term “processor” refers to one or more hardware processors, processing circuits, or processing units, which may be implemented by a central processing unit (CPU), graphics processing unit (GPU), dedicated integrated circuit, or any combination thereof, configured to execute instructions and perform the operations described in the claims.

The term “text data input by a user” refers to character-based information, such as words, sentences, or paragraphs, that is entered by a human user through an input device, including but not limited to a keyboard, touch panel, or voice recognition interface.

The term “classify information by assigning numerical values representing importance and relevance” refers to processing in which the processor evaluates elements of the input text data, assigns scores or weights that quantitatively indicate how important and how contextually related each element is, and groups or orders the elements based on those scores or weights.

The term “class newsletter format” refers to a predefined or configurable structure suitable for communicating information from a teacher or educational institution to students, parents, or guardians, including sections such as event announcements, reminders, and class activity reports.

The term “prompt” refers to a structured data string, message, or instruction set that is provided as input to a generative AI model or other processing module, and that specifies the task, constraints, style, or other parameters for generating an output.

The term “generative AI model” refers to a machine learning model, such as a large language model or multimodal generative model, that is capable of generating new content, including natural-language text or layout proposals, in response to a given prompt.

The term “body text of the class newsletter” refers to the main textual content of the newsletter, excluding ancillary elements such as titles, headers, footers, or system-generated metadata, and including narrative, explanations, announcements, and instructions intended for recipients.

The term “visually understandable layout” refers to an arrangement of textual elements and image elements on a display area or page, in which positions, sizes, and relationships among the elements are determined so that a reader can easily perceive and comprehend the information.

The term “template” refers to a predefined layout pattern or design structure that specifies regions, styles, and relationships for placing text and images, and that is applied by the processor as a basis for creating the visual layout of the class newsletter.

The term “image information” refers to data representing static visual content, including but not limited to photographs, illustrations, icons, or other graphic elements, in any digital image format recognized by the system.

The term “image recognition technique” refers to an algorithm, software module, or model that analyzes image data to extract features or identify content, such as objects, persons, scenes, or attributes, used for classification, selection, or annotation of images.

The term “appropriate images” refers to one or more images that are selected by the processor based on their content, relevance to the text of the class newsletter, and suitability for the intended audience, including considerations of privacy, fairness, and context.

The term “visual balance” refers to a condition of the layout in which text and images are distributed in a manner that avoids overcrowding or empty regions and provides a harmonious and comfortable visual impression to a typical reader.

The term “input history of the user” refers to a record of past interactions by the user with the system, including previously entered text, commands, corrections, or selections.

The term “browsing history of the user” refers to a record of content viewed or accessed by the user within the system or related services, such as previously generated newsletters, help pages, or reference materials.

The term “real-time facial expression recognition” refers to processing that analyzes images or video of the user's face, captured in real time by a camera or similar device, to estimate facial expressions and infer an emotional state.

The term “emotional state of the user” refers to an internal affective condition or mood of the user, such as calmness, stress, satisfaction, or frustration, that is inferred by the system based on at least one of the user's input history, browsing history, and real-time facial expression recognition.

The term “optimization of expressions according to the emotional state” refers to adjustment of wording, tone, or style of the text content generated for the class newsletter so that it is more likely to be acceptable, comfortable, or supportive in light of the inferred emotional state of the user.

The term “optimized contents of the class newsletter” refers to the contents of the newsletter after completion of analysis, classification, layout processing, image selection, and emotional-state-based adjustments, such that the contents are improved in clarity, readability, engagement, or emotional suitability.

The term “printed format” refers to a form of output suitable for physical printing, including but not limited to a print-ready page description, layout data, or a file such as a PDF intended for output onto paper.

The term “digital format” refers to a form of output suitable for electronic distribution or display, including but not limited to HTML, PDF, image files, or other electronic document formats.

The term “final output data” refers to data representing the completed class newsletter, including all optimized text, layout, and selected images, in a format ready for printing, storage, or digital distribution.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

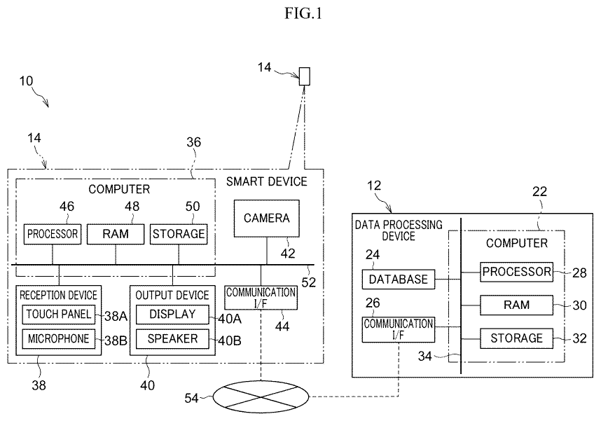

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

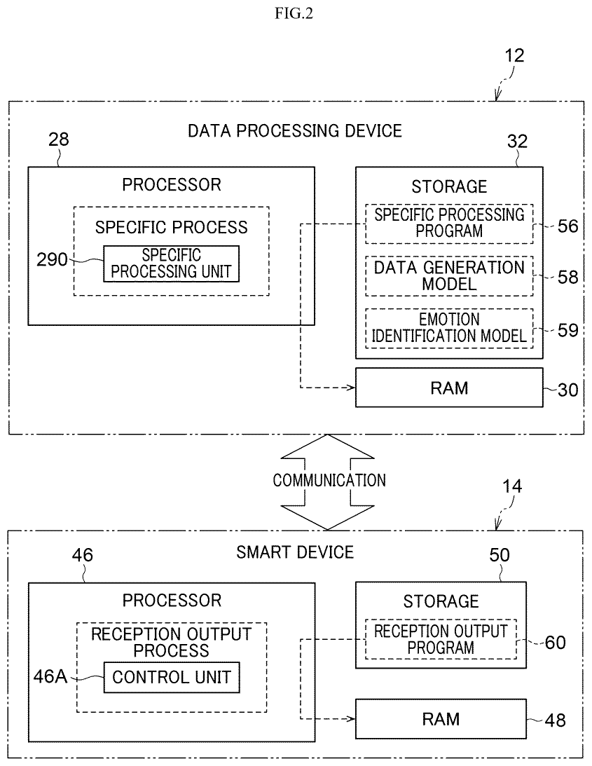

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for assisting preparation of class newsletters primarily provide static templates and simple text editing functions. In such systems, processing of user input text is limited to rudimentary formatting, and does not include machine-level understanding of semantic importance, relationships among pieces of information, or dynamic optimization of layout and visual balance. As a result, even when a generative AI model is naively invoked to produce text, the underlying computer system behaves as a thin pass-through layer that merely forwards user instructions and generated text, without performing substantive computational transformations. This leads to several technical problems.

First, existing systems fail to efficiently structure heterogeneous input text into machine-usable representations that a computer can leverage to control a generative AI model and downstream layout engines. For example, information relating to events, belongings, and cautions is often embedded in a single unstructured text block. In such cases, the processor cannot effectively determine importance hierarchies or relationships among items, causing inefficient prompt construction and suboptimal utilization of the generative AI model. This lack of structured intermediate representations results in additional processing rounds, redundant calls to the model, and increased computational overhead.

Second, traditional workflows do not integrate prompt generation, model output restructuring, layout computation, and image selection into a coherent, iterative pipeline. The computer typically treats the generative AI model output as final-form human text rather than as data to be further analyzed and transformed. Because there is no systematic feedback loop in which structured content and layout information are repeatedly recomputed and fed back into the generative AI model, the system cannot efficiently converge to an optimized document. This leads to excessive manual edits by users, unnecessary re-rendering, and wasteful consumption of processing and network resources.

Third, existing document-authoring tools seldom provide a mechanism by which the processor itself automatically derives prompt sentences for both text generation and image generation, based on machine-interpretable content structures. Image insertion is frequently handled manually or via static icon sets that are not semantically aligned with the generated content. Consequently, visual balance and readability depend heavily on user skill, and the computer system does not perform meaningful algorithmic optimization of the document's visual structure.

Fourth, when personalization based on recipient behavior is attempted, many systems implement such features at the level of business logic only, with minimal integration into the core document generation pipeline. Behavior data such as viewing history, selection history, or response history are not transformed into quantitative importance scores that influence both prompt construction and layout computation. As a result, the computer does not fully exploit historical data to adjust the internal representation of content importance, and cannot systematically steer the generative AI model or layout rendering engine toward personalized optimization.

Fifth, user interfaces intended for non-expert users often rely on a large number of discrete configuration options, which require users to manually adjust detailed settings. This increases cognitive load and frequently results in inefficient interactions, including repeated trial-and-error rendering. The underlying computer system does not effectively use the user's high-level interactions to automatically regenerate prompts and layout parameters, and thus cannot reduce the number of processing cycles and network calls required to reach a satisfactory document.

Accordingly, there is a need for an improved computer-implemented system that (i) transforms raw user input into structured content representations with quantified importance and relationships, (ii) automatically constructs and refines prompt sentences for generative AI models, (iii) programmatically restructures model outputs for layout computation, (iv) algorithmically selects and positions images to achieve visual balance, (v) incorporates behavioral data to refine importance scores and prompts, and (vi) uses user interactions with an interface to drive automatic, iterative optimization. By integrating these operations into a coherent processing pipeline, the computer system can reduce redundant processing, improve efficiency in the use of generative AI resources, and output optimized electronic document data with reduced manual intervention, thereby improving the functioning of the computer itself in generating complex, layout-sensitive documents.

The specific processing by the specific processing unit 290 of the data processing device 12 in Example 1 is realized by the following means.

The present invention provides a server comprising a processor and a memory storing instructions which, when executed by the processor, cause the processor to receive, from a terminal operated by a user, text information for a class newsletter; to perform computational analysis on the text information to extract multiple information units including event-related units, belonging-related units, caution-related units, and other units; to quantify an importance and a relevance of each of the information units and to classify the information units based on the quantified values so as to form structured data; to algorithmically reconstruct the structured data into a machine-usable section structure and heading structure that conforms to a class newsletter format; to generate, based on the structured data, a first prompt sentence configured to cause a generative AI model to generate a draft body text; to input the first prompt sentence into the generative AI model via a programmatic interface and obtain the draft body text as machine-readable response data; to parse and restructure the draft body text into paragraph information, list information, and heading information suitable for further automated processing; to compute layout information for the restructured draft body text by determining, according to the quantified importance and information types, font sizes, emphasis levels, and placement orders for different portions of the text; to generate, based on the layout information, a second prompt sentence configured to cause generation of a visually understandable layout, and to generate layout data by applying a layout template that programmatically combines character information and image information.

The instructions further cause the processor to analyze the draft body text and the structured data to extract keywords corresponding to concepts; to perform a machine-based selection of candidate images by matching the keywords with stored image attribute data; when necessary, to generate a third prompt sentence configured to cause an image-generating generative AI model to generate insertion images and to obtain generated images as machine-processable data; and to algorithmically assign the candidate images or the generated images to positions within the layout data in accordance with content categories and visual balance constraints. The instructions also cause the processor to receive, from the terminal, additional instructions or correction instructions; to construct a revision prompt sentence including the additional or correction instructions together with at least a portion of the current draft body text; to input the revision prompt sentence into the generative AI model and obtain a revised draft body text; and to iteratively re-execute the classification, the computation of the layout information, and the image assignment using the revised draft body text so that the contents and layout of the class newsletter are repeatedly optimized within the computational pipeline.

The instructions further cause the processor to transform optimized layout data into final electronic document data by generating an output prompt sentence configured to specify a target format including a print-use electronic document format or a display-use electronic document format, and by executing a rendering process that converts the layout data into final output data; and to output the final output data to at least one of a printing device and a display device as a paper medium or an electronic medium. This enables the computer system to perform a series of technical operations that convert unstructured user text into structured representations, drive generative AI models through automatically constructed prompt sentences, iteratively refine both textual content and layout in response to user interactions and historical behavior data, and generate optimized document data with reduced manual editing and rendering cycles, thereby improving efficiency, scalability, and reliability of computer-based document generation.

The term “processor” refers to a hardware execution unit, such as a central processing unit or a graphics processing unit, that executes instructions to perform arithmetic, logical, control, and input/output operations.

The term “memory” refers to a hardware storage device, such as a volatile or non-volatile storage medium, that stores instructions and data to be accessed and processed by the processor.

The term “terminal” refers to an information processing device, such as a personal computer, tablet, or smartphone, that provides an input/output interface through which a user interacts with the system.

The term “user” refers to a human operator who uses the terminal to input information, issue instructions, and confirm or modify results produced by the system.

The term “text information for a class newsletter” refers to character-based data input by the user and intended to be used as source content for generating a newsletter document related to educational activities of a class.

The term “information unit” refers to a logically grouped portion of the text information, such as an event-related item, a belonging-related item, a caution-related item, or any other semantically coherent segment that can be individually processed.

The term “importance” refers to a quantified measure indicating a relative priority or significance of an information unit within the overall content of the class newsletter.

The term “relevance” refers to a quantified measure indicating a degree of association between an information unit and other information units or specific categories within the class newsletter.

The term “structured data” refers to data organized into a predefined format, such as records, fields, or labeled elements, that explicitly represents relationships, categories, and attributes of the information units.

The term “section structure” refers to an arrangement of content into discrete segments, such as headings and subheadings, that define logical parts of the class newsletter.

The term “heading structure” refers to a hierarchical organization of titles, subtitles, and labels that identify and distinguish sections and subsections within the class newsletter.

The term “class newsletter format” refers to a predefined document organization pattern including sections, headings, and layout rules suitable for communicating class-related information to recipients.

The term “prompt sentence” refers to a machine-readable instruction string provided to a generative AI model, specifying constraints, content, style, or structure to guide generation or modification of text or images.

The term “generative AI model” refers to a machine learning model configured to generate data, such as text or images, in response to input prompts, based on parameters learned from training data.

The term “draft body text” refers to a preliminary generated textual version of the main content of the class newsletter that is subject to further processing and refinement.

The term “paragraph information” refers to structured representations of text blocks that are separated as paragraphs, each comprising one or more sentences grouped by topic or function.

The term “list information” refers to structured representations of grouped items, such as bullet lists or numbered lists, extracted from or constructed within the draft body text.

The term “heading information” refers to structured representations of text elements that function as titles or labels for sections or subsections within the draft body text.

The term “layout information” refers to data indicating visual presentation parameters, including font size, emphasis level, placement order, and positional relationships for text and images within a document.

The term “emphasis level” refers to a degree of visual highlighting applied to a text element, such as bolding, underlining, or color change, reflecting its relative importance.

The term “layout template” refers to a predefined set of rules or patterns specifying arrangement of text, images, and other elements on one or more pages of a document.

The term “layout data” refers to machine-readable data defining positions, sizes, and styles of text and images according to a layout template and layout information.

The term “character information” refers to digital data representing textual content in a character-encoded form suitable for rendering.

The term “image information” refers to digital data representing visual content, such as bitmap images or vector graphics, suitable for insertion into a document.

The term “keyword” refers to a word or phrase extracted from text that is used as a feature for categorization, retrieval, or association with other data, such as images.

The term “image attribute data” refers to metadata describing properties of images, including associated concepts, categories, tags, or usage contexts, used to select suitable images.

The term “candidate image” refers to an image selected as a potential element for insertion into the class newsletter based on correspondence between keywords and image attribute data.

The term “image-generating generative AI model” refers to a generative AI model that produces image data in response to input prompts, based on learned visual patterns.

The term “insertion image” refers to an image generated or selected for embedding into the layout data of the class newsletter at one or more positions.

The term “visual balance” refers to a property of a layout indicating a harmonious distribution of text and images, improving readability and aesthetic quality.

The term “additional instructions” refers to user-provided commands or preferences that specify modifications, additions, or refinements to be applied to the current draft body text or layout.

The term “correction instructions” refers to user-provided directions specifying concrete corrections, such as changes to wording, emphasis, or factual details, to be applied to the draft body text.

The term “revision prompt sentence” refers to a prompt sentence that includes at least part of an existing draft body text together with additional or correction instructions, and that is provided to a generative AI model for revising the text.

The term “optimized layout data” refers to layout data that has been adjusted based on importance, relevance, user instructions, and visual balance to achieve an improved document structure and appearance.

The term “print-use electronic document format” refers to an electronic document representation configured for high-quality printing, such as a page-description format with fixed layout.

The term “display-use electronic document format” refers to an electronic document representation configured for on-screen viewing, such as a format optimized for display devices and interactive viewing.

The term “final output data” refers to electronic document data produced after all content generation, layout computation, and optimization steps, which is ready for printing or display. The term “interactive screen” refers to a graphical user interface presented on the terminal that receives user inputs and immediately reflects operations by updating displayed elements. The term “guidance message” refers to a textual or symbolic indication on the interactive screen that instructs or assists the user in performing operations.

The term “viewing history information” refers to data indicating how recipients have accessed or viewed previous class newsletters, including metrics such as access frequency or duration.

The term “selection history information” refers to data indicating interactions by recipients with selectable elements of previous class newsletters, such as clicks or selections of links or sections.

The term “response history information” refers to data indicating feedback or responses provided by recipients with respect to previous class newsletters, such as survey answers or message replies.

The term “reaction tendency” refers to a pattern of behavior inferred from viewing, selection, and response history information, indicating how recipients typically engage with specific types of content.

In one embodiment, a server, a terminal, and a network cooperate to implement a system that generates class newsletters by using a generative AI model under explicit control of a prompt sentence generation mechanism and a layout computation mechanism. The server includes at least one processor, such as a multicore central processing unit (CPU) and optionally a graphics processing unit (GPU), and a memory that stores executable instructions and data structures. The terminal is, for example, a tablet computer, a notebook computer, or a smartphone executing a web browser such as a standards-compliant HTTP client. The server and the terminal communicate via a communication network using a protocol such as HTTPS.

The server executes an application program implemented, for example, as a web application in a server-side runtime environment such as a Python-based framework (e.g., Flask or FastAPI) or a JavaScript-based framework (e.g., Node.js with Express). The server also uses auxiliary software components including a relational database management system (e.g., PostgreSQL or MySQL) to store structured data, a document rendering engine (e.g., wkhtmltopdf, a headless Chromium instance controlled by a browser automation framework, or a PDF generation library such as ReportLab) to create electronic documents, and an HTTP client library (e.g., a Python requests library or a JavaScript HTTP client) to communicate with an external generative AI service. The memory of the server stores pre-defined templates for layout, mappings between keywords and image attributes, and trained parameter sets for one or more generative AI models, which may be hosted remotely and accessed through an API.

The terminal executes a web browser that renders an interactive screen transmitted from the server. The terminal displays input fields, icons, and buttons that allow a user to enter raw text for a class newsletter. The user operates the terminal to input textual content such as event schedules, required belongings, and cautionary notes. The terminal sends the user's input to the server as structured data, for example, as a JSON-encoded HTTP request body, and receives preview data and final document data generated by the server. The user views and confirms the generated newsletter on the terminal and optionally issues additional instructions or correction instructions.

The server uses specific data structures to represent and transform user input. In one embodiment, the server converts received text into an internal representation comprising: (i) a token sequence representing individual words and punctuation, (ii) an information-unit list in which each element corresponds to an “information unit” (such as an event, a belonging item, or a caution item), and (iii) a set of numerical attributes for each information unit. The server assigns an “importance” attribute and a “relevance” attribute to each information unit. The importance attribute is a numerical value (e.g., a real number in a normalized range [0, 1] or a discrete score) that indicates priority within the document. The relevance attribute represents a degree of association with particular section categories (e.g., event information, belongings, cautions).

The server computes these attributes using a combination of rule-based processing and statistical models. For example, the server applies keyword matching rules that assign base importance values to items that match predefined patterns (such as “deadline,” “must,” or date expressions). The server also uses a lightweight classifier, such as a neural network with one or more fully connected layers, to refine the importance scores based on features including part-of-speech patterns, sentence length, and location within the input. By combining rule-based and learned criteria, the server generates structured data with more accurate importance and relevance values, improving subsequent layout computation and prompt sentence construction.

The server transforms the structured data into a section structure and a heading structure suitable for a class newsletter format. The server allocates information units to logical sections, such as “Greeting,” “Event Information,” “Items to Bring,” and “Cautions,” according to the relevance attributes and predefined mapping rules. For example, information units that contain date expressions and activity keywords are assigned to an event section, while information units containing noun phrases describing objects (e.g., “boxed lunch,” “water bottle,” “hat”) are assigned to a belongings section. This transformation produces a machine-usable section structure that explicitly encodes the content organization.

The server constructs a prompt sentence for a generative AI model based on the structured data and the section structure. The prompt sentence includes explicit instructions about desired tone, length, and document organization, and incorporates the extracted information units in a structured manner. For example, the server may generate a prompt sentence such as:

“Act as a teacher preparing a class newsletter for parents.

Create a draft of an October class newsletter using the following information:
Event: Field trip
Date: October 15
Items to bring: boxed lunch, water bottle, hat
Cautions: please arrive by 8:30, wear comfortable shoes.

Organize the newsletter into a greeting, an event description, a clear list of items to bring, and important cautions.

Use a friendly and polite tone, and keep the total length to about one A4 page.”

By generating the prompt sentence from structured data, the server improves the consistency and precision of the instructions given to the generative AI model, which in turn improves generation speed and reduces the number of re-generation iterations required.

The server interacts with a generative AI model that is implemented, for example, as a transformer-based neural network trained on large-scale text corpora. The generative AI model includes multiple layers of self-attention and feed-forward sub-layers, and is trained using a language modeling objective that minimizes a loss function such as cross-entropy between predicted token distributions and ground-truth tokens. During training, the model updates its internal weight parameters via gradient-based optimization, such as stochastic gradient descent or Adam, and adjusts attention weights to capture long-range dependencies and contextual relationships. In one embodiment, the generative AI model is provided as a remote service; the server sends the constructed prompt sentence to this service and receives generated text as a sequence of tokens.

The server does not treat the generative AI model as a black box that simply replaces human writing. Instead, the server uses the generative AI model as a component in a pipeline that the server controls through prompt sentences and downstream structural analysis. The server parses the generated output into paragraphs, lists, and headings by analyzing line breaks, bullet markers, and lexical cues. For example, the server identifies headings by detecting lines with capitalization patterns or preceding blank lines, and identifies lists by recognizing patterns such as “-” or “.” at the beginning of lines. The server converts this parsed output into an internal representation with explicit paragraph information, list information, and heading information.

The server then computes layout information for each content element. The server uses the pre-computed importance and relevance attributes, as well as section type information, to determine font sizes, emphasis levels, and placement orders. For example, in one embodiment, the server selects larger fonts and bold styling for items whose importance scores exceed a threshold, and places such items toward the top of the page or near section boundaries. The server represents layout information in a data structure that includes a position index, font size, style attributes (e.g., bold, italic), and relative ordering parameters. The server uses this layout information together with a layout template to create layout data that specifies the positions of character information and image information on a page.

The server selects images to insert into the layout by analyzing the content of the draft body text and the structured data. The server extracts keywords corresponding to concepts such as “field trip,” “lunch,” “water bottle,” and “hat.” The server maintains an image attribute database in which each stored image has associated metadata including keyword tags, category labels, and recommended usage contexts. The server performs a mapping from extracted keywords to image attributes using string matching and similarity scoring methods. When an appropriate stored image is not available, the server generates an image via an image-generating generative AI model, which may also be implemented as a neural network (e.g., a diffusion-based model or a generative adversarial network) trained with an image reconstruction or generation loss function. The server constructs an image generation prompt sentence, such as:

“Generate a simple, child-friendly illustration of elementary school children going on an autumn field trip, carrying a water bottle and wearing a hat.”

The server sends this prompt sentence to the image-generating model and receives image data. The server then assigns the selected candidate images or generated images to specified positions within the layout data according to rules that balance text density and visual distribution. For example, the server may place a hat icon adjacent to the item “hat” in the belongings list, or place a large event illustration near the top of the event section.

The server further allows iterative refinement through additional instructions or correction instructions from the user. The terminal displays a preview of the newsletter layout and provides an area where the user can enter changes such as “Please shorten the greeting to two sentences and emphasize the arrival time of 8:30.” The terminal sends these instructions to the server, which constructs a revision prompt sentence that combines the existing draft body text with the instructions. An example of such a revision prompt sentence is:

“You are revising the following class newsletter draft.

[Current draft text here]

Please revise the draft according to these instructions:
Shorten the greeting to about two sentences.
Emphasize that students must arrive by 8:30.

Return the entire revised newsletter text.”

The server submits the revision prompt sentence to the generative AI model, receives a revised draft, and then re-applies the same parsing, structuring, importance scoring, and layout computation steps. By reusing structured representations and layout information, the server reduces the time required to generate updated preview data and avoids recomputing unchanged parts of the layout. This iterative process improves computational efficiency by limiting re-rendering and excessive network calls.

The server also uses behavior data to improve document personalization and technical performance. The server stores viewing history information, selection history information, and response history information of recipients as structured records with fields indicating which sections were viewed or interacted with, for how long, and what feedback was given. The server aggregates these records to derive reaction tendencies for different content types. The server then adjusts importance scores of information units by applying weighting functions that increase importance for content types that historically correspond to high engagement. Based on these adjusted scores, the server modifies layout decisions and constructs prompt sentences that emphasize content of higher interest. This integration of behavioral data into both prompt sentence generation and layout computation results in fewer manual revisions and more effective use of generative AI resources, which constitutes an improvement in the underlying computer-assisted document generation process.

From a technical perspective, the described system improves computer technology in several ways. The server reduces redundant computations and network traffic by (i) converting raw text into structured data that feeds directly into prompt sentence construction and layout computation, (ii) maintaining intermediate representations that support incremental updates, and (iii) limiting the generative AI calls to well-scoped tasks. Because the server controls the generative AI model through precisely formulated prompt sentences derived from structured representations, the system requires fewer trial-and-error iterations and generates output closer to the final desired form, thereby reducing processing time and energy consumption. The server also uses explicit importance and relevance scores, rather than only free-form text, as control signals for layout and style decisions, which allows deterministic and repeatable document rendering, in contrast to purely manual or ad hoc editing workflows.

Furthermore, the server exploits the structured representations to control external document rendering engines. The layout data generated by the server directly specifies page size, margin sizes, font selection, and image placement, which the document rendering engine uses to create print-use and display-use electronic document formats. This amounts to specific control of document rendering hardware and software, including printer drivers and display devices, rather than merely outputting text. The server can, for instance, automatically generate print-optimized PDFs with embedded fonts and fixed page boundaries, which reduces printing errors and misalignment, and can generate display-optimized formats that minimize scrolling and enhance readability on small screens.

The system uses an internal modular architecture in which functional modules correspond to content analysis, importance scoring, prompt sentence generation, generative model interfacing, layout computation, image selection, and document rendering. Variations of the embodiment may employ different neural network architectures (e.g., transformer variants, recurrent neural networks, or hybrid models) for the generative AI model, and may use different training procedures or loss functions tailored to newsletter-style documents. The system may also use alternative layout templates, different image attribute schemas, or additional personalization criteria. However, in each embodiment, the server consistently applies a non-conventional processing pipeline that combines structured representation, algorithmic importance scoring, and prompt sentence control of a generative AI model, thereby achieving improved accuracy, reduced latency, and lower computational cost in the automatic generation of complex, layout-sensitive class newsletters.

Because the server performs these operations as machine-level data processing that is not limited to mere business logic, but instead involves specialized data structures, controlled model interactions, and explicit control of output devices, the invention goes beyond simple automation of human tasks. The invention improves the internal functioning of a computer-based document generation system and provides technical effects in processing speed, generation precision, layout quality, and resource utilization.

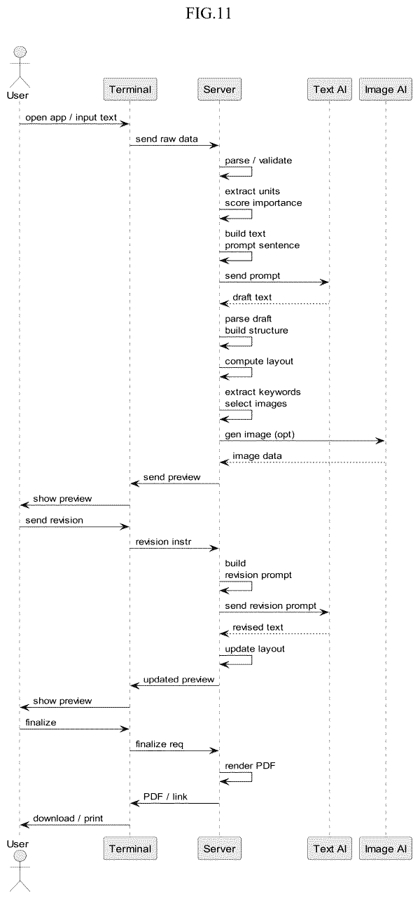

The following describes the processing flow using FIG. 11.

### Step 1:

The user operates the terminal to launch a web browser and access a URL of a web application provided by the server.

The terminal sends an HTTP GET request to the server as input.

The server receives the request and outputs an HTML document, style sheets, and JavaScript code that define an interactive screen for creating a class newsletter.

The terminal renders the received HTML and scripts, and displays input fields, icons, and buttons for entering event information, belongings, and cautions.

### Step 2:

The user operates the terminal to input raw text information for the class newsletter into the displayed input fields.

The terminal takes the user's keystrokes and selections as input and updates a Document Object Model (DOM) structure held in the browser.

The terminal constructs an internal data object containing fields such as event date, event description, items to bring, and cautions, and outputs this object when the user activates a “Create Draft” or similar button.

### Step 3:

The terminal sends the constructed data object to the server in an HTTP POST request, typically in a JSON format.

The server receives the JSON payload as input and parses it using a JSON parser to transform it into internal variables or data structures.

The server outputs a normalized representation of the user input, for example, a dictionary or record structure ready for further analysis.

### Step 4:

The server takes the normalized input data as input and performs validation and normalization processing.

The server checks that mandatory fields such as dates and main text are present, verifies that dates match a predetermined format, and trims unnecessary whitespace in text fields.

The server performs data operations including string trimming, pattern matching for date formats, and length checks.

The server outputs validated and normalized data, including corrected date strings and cleaned text segments, and stores this data in a database or in-memory session store.

### Step 5:

The server receives the validated data as input and extracts information units such as individual events, individual belonging items, and individual cautions.

The server performs data processing such as tokenization of text, splitting on punctuation or list delimiters, and identification of key phrases using rule-based patterns.

The server outputs a list of information units, where each unit includes fields such as type (event, belonging, caution), raw text, and location in the original input.

### Step 6:

The server takes the list of information units as input and computes an importance score and a relevance score for each unit.

The server executes an algorithm that uses rule-based scoring (for example, assigning higher scores to text containing deadline words or safety-related terms) and optionally a lightweight classifier that evaluates features such as position and key phrases.

The server performs numeric operations including feature extraction, multiplication of feature weights, and normalization to a defined range.

The server outputs a structured list of information units, each enriched with numerical importance and relevance attributes.

### Step 7:

The server receives the enriched information units as input and constructs a section structure and heading structure suitable for a class newsletter.

The server applies mapping rules that group information units with similar relevance types into sections such as “Event Information,” “Items to Bring,” and “Cautions.”

The server performs data operations including sorting, grouping, and labeling of information units to form sections with associated headings.

The server outputs a structured representation of the newsletter's logical organization, including ordered sections and their associated information units.

### Step 8:

The server takes the section structure and heading structure as input and generates a prompt sentence for a generative AI model.

The server uses a template that specifies role, tone, and document organization, and fills placeholders with concrete values from the section structure, such as event dates and item lists.

The server performs string concatenation and formatting operations to assemble a coherent instruction text.

The server outputs a prompt sentence such as:

“Act as a teacher preparing a class newsletter for parents.

Create a draft using the following information:
Event: field trip on October 15
Items to bring: boxed lunch, water bottle, hat
Cautions: please arrive by 8:30, wear comfortable shoes.

Organize the newsletter into a greeting, an event description, a clear list of items to bring, and important cautions.

Use a friendly and polite tone, and keep the total length to about one A4 page.”

### Step 9:

The server takes the prompt sentence as input and sends it to a generative AI model through an API call.

The server uses an HTTP client library to construct a request body including model identifier, parameters such as temperature, and the prompt sentence.

The server performs network communication processing over HTTPS and waits for a response.

The server receives as output a generated draft body text from the generative AI model, represented as a sequence of tokens or a text string.

### Step 10:

The server takes the generated draft body text as input and parses it into paragraph information, list information, and heading information.

The server performs text processing operations including detection of line breaks, detection of list markers such as “-” and numbering, and pattern matching for headings.

The server organizes the text into structured elements, each annotated with type (paragraph, list item, heading) and position.

The server outputs a hierarchical representation of the draft body text, suitable for layout computation.

### Step 11:

The server receives the hierarchical representation together with the importance and relevance attributes as input and computes layout information.

The server executes an algorithm that maps importance scores to visual parameters such as font size and emphasis level, and maps section order to placement order on the page.

The server performs numeric operations such as scaling importance scores to font-size ranges and ranking sections for ordering.

The server outputs layout information for each content element, including calculated font size, style attributes, and relative placement indices.

### Step 12:

The server takes the draft body text and structured data as input and extracts keywords for image selection.

The server applies keyword extraction rules or a simple statistical method to identify nouns and noun phrases representing objects, events, and concepts.

The server uses these keywords as query keys to search an image attribute database, performing lookups and similarity matching.

The server outputs a set of candidate images for each relevant keyword, each with associated usage metadata.

### Step 13:

The server receives the candidate images and, when necessary, constructs an image generation prompt sentence for an image-generating generative AI model.

The server analyzes which concepts lack suitable stock images and creates natural language descriptions such as:

“Generate a simple, child-friendly illustration of children on an autumn field trip, carrying a water bottle and wearing a hat.”

The server sends this prompt sentence to the image-generating model and receives image data as output.

The server combines stock images and generated images to produce a final list of images available for layout.

### Step 14:

The server takes the layout information, the structured content, and the list of available images as input and assigns images to positions within the layout data.

The server applies rules that align specific images with related content segments, for example placing a hat icon next to “hat” in the belongings list.

The server performs positioning computations that balance text density and image distribution across the page.

The server outputs complete layout data that includes both text elements and image elements, each with assigned coordinates and style parameters.

### Step 15:

The server takes the complete layout data as input and generates a preview document in a display-use electronic document format, such as HTML with embedded styles and image references.

The server uses a layout engine to convert internal coordinates and styles into concrete HTML structures and CSS declarations.

The server outputs preview data that specifies how text and images will appear on the terminal's display.

The terminal receives the preview data and renders it on the screen, showing the user a visual preview of the newsletter.

### Step 16:

The user views the preview on the terminal and decides whether modifications are necessary. The user inputs additional instructions or correction instructions into a designated input area on the terminal.

The terminal takes the user's textual instructions as input and constructs a data object containing the instructions and an identifier of the current draft.

The terminal outputs this data object to the server in an HTTP POST request.

### Step 17:

The server receives the instructions and the draft identifier as input and retrieves the corresponding draft body text and structured data from storage.

The server combines the existing draft text and the user's instructions into a revision prompt sentence.

The server performs string concatenation and formatting operations to construct a prompt sentence such as:

“You are revising the following class newsletter draft.

[Current draft text]

Please revise the draft according to these instructions:
Shorten the greeting to about two sentences.
Emphasize that students must arrive by 8:30.

Return the entire revised newsletter text.”

The server outputs this revision prompt sentence for use in a subsequent generative AI call.

### Step 18:

The server sends the revision prompt sentence as input to the generative AI model via the API.

The server processes the model's response, performing the same parsing operations as before to convert the revised text into paragraphs, lists, and headings.

The server reuses previously computed importance and relevance attributes where applicable, and recalculates them for altered segments.

The server outputs an updated structured representation and updated layout information reflecting the revised content.

### Step 19:

The server takes the updated structured representation and layout information as input and re-generates the layout data.

The server adjusts positions, font sizes, and image placements only where content has changed, minimizing recomputation.

The server outputs updated preview data in the same display-use electronic document format as before.

The terminal receives and renders the updated preview, allowing the user to confirm the revised newsletter.

### Step 20:

The user confirms the final version of the newsletter on the terminal and initiates a finalization operation.

The terminal sends a finalization request including the draft identifier to the server as input.

The server receives this request and retrieves the latest layout data associated with the identifier.

The server outputs a signal to initiate generation of final output data.

### Step 21:

The server takes the layout data as input and generates a print-use electronic document format, such as a PDF file.

The server controls a rendering engine to convert layout coordinates, fonts, and images into a page-description representation with fixed page size and margins.

The server performs operations such as font embedding, image encoding, and pagination.

The server outputs final output data suitable for printing or archival storage.

### Step 22:

The server sends the final output data or a download URL to the terminal as output.

The terminal receives the final output data as input and either starts a file download or displays the document with a viewer.

The user saves the file or prints it using a printing device connected to the terminal or to a network.

The user then distributes the printed or electronic newsletter to recipients, completing the end-to-end process controlled by the server using structured data, layout computation, and generative AI model interactions guided by prompt sentences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for generating visual communication materials, such as posters, notices, newsletters, and other information-distribution media, require a human operator to perform multiple fragmented operations: structuring raw textual information, drafting suitable body text, designing a layout, selecting appropriate images, and formatting final output data for print or digital display. In typical workflows, each of these operations is executed in separate software components (for example, a word processor, a layout editor, and an image editor), and data must be manually passed between them. As a result, overall processing is slow, error-prone, and highly dependent on the operator's design skill and experience.

In particular, when generative AI models are introduced into this workflow, conventional systems often use them in an ad-hoc, single-step manner, such as merely generating text or merely generating an image from a simple natural-language prompt. The construction of prompt sentences is usually left to the user, who must manually encode domain context, layout requirements, target audience characteristics, and other constraints into free-form text. This causes several technical problems: (i) unstable output quality because prompt sentences are inconsistent; (ii) increased computational load and wasted API calls due to trial-and-error prompting; and (iii) difficulty in integrating the generative AI model's outputs into a structured pipeline that can automatically produce machine-processable layout data and final output data.

Furthermore, conventional systems do not exploit structured event or notification data (for example, time, place, benefits, campaign parameters) as a first-class input for automated content generation. As a result, regular or recurring information cannot be efficiently updated, and the system cannot automatically regenerate visually attractive content when only a subset of parameters changes. This leads to redundant recomputation and repeated manual operations, which increases latency and resource consumption in the server and prevents efficient use of network bandwidth and external generative AI resources. Additionally, existing systems rarely integrate user-specific behavioral data and estimated emotional state into the prompt-construction pipeline at the system level. Although some recommendation engines adjust which content is shown, they do not technically restructure prompt sentences or layout generation strategies according to input history, viewing history, and emotional estimations. Consequently, the generative AI model is not optimally conditioned, and the system cannot systematically optimize the information-distribution medium for different recipients while maintaining deterministic processing steps and machine-interpretable intermediate data.

Therefore, there is a need for an improved computer-implemented system that (i) automatically converts structured user input into a sequence of specialized prompt sentences for text generation, layout generation, image selection, and output formatting; (ii) coordinates communications with a generative AI model through a clearly defined interface; (iii) reuses and updates structured data for recurring events; and (iv) integrates behavioral and emotional estimation data into the prompt-generation pipeline. Such a system should improve the efficiency, reliability, and scalability of the overall content-generation process from a computer-technical perspective, reduce unnecessary computation and network calls, and produce machine-processable layout and output data suitable for both print and digital environments.

The specific processing by the specific processing unit 290 of the data processing device 12 in Application Example 1 is realized by the following means.

The present invention provides a server comprising a processor configured to (i) parse character information input by a user, quantify and classify an importance level and a relevance level of pieces of the character information, and organize the classified information so as to conform to a predetermined information-distribution medium format; (ii) construct, based on the organized information, a first prompt sentence that instructs a generative AI model to generate body data of the information-distribution medium, input the first prompt sentence into the generative AI model, and acquire the body data generated by the generative AI model; (iii) construct, based on the body data, a second prompt sentence that instructs generation of a visually understandable layout, select a template applicable to layout information, and create visual layout data by combining text information and image information according to the template; (iv) perform image recognition processing on image data of candidate images to be inserted into the information-distribution medium, analyze content of the image data, construct a third prompt sentence that instructs selection of an image suitable for content and visual balance of the information-distribution medium, and arrange a selected image in an image region in the visual layout data; (v) periodically acquire event information or notification information input by the user, generate structured data including the event information or the notification information, automatically convert the structured data into at least one text-generation prompt sentence and at least one image-generation prompt sentence, and automatically generate visually attractive content by using the generative AI model; (vi) receive, via a communication network, the structured data transmitted from a terminal, transmit to an interface of the generative AI model at least one prompt sentence corresponding to the structured data together with generation parameters, and return content data acquired from the generative AI model to the terminal; (vii) specify content elements and visual expressions that are likely to attract interest of a recipient based on at least one of an input history of the user, a viewing history of the user, and estimation information regarding an emotional state of the user, construct a fourth prompt sentence that instructs adjustment of expression content in accordance with a result of the specification, and optimize content of the information-distribution medium according to the fourth prompt sentence; and (viii) construct a fifth prompt sentence that instructs output of optimized visual layout data and the content data as print data or electronic display data, and generate final output data based on the optimized visual layout data and the content data. This enables a technically improved content-generation pipeline in which structured user input is deterministically transformed, via multiple stages of machine-generated prompt sentences and controlled interactions with a generative AI model, into optimized visual communication data, thereby reducing manual operations, stabilizing output quality, decreasing redundant computation and network traffic, and enhancing the efficiency and scalability of computer resources used for generating information-distribution media.

The term “processor” refers to a hardware or virtual computation element, such as a central processing unit or a processing core in a computing device, that executes machine-readable instructions to perform data processing operations described in this specification.

The term “character information” refers to information expressed as text data, including letters, numbers, symbols, and punctuation, that is input by a user and processed as machine-readable textual content.

The term “user” refers to a human operator who interacts with a terminal or other input device to provide character information, event information, notification information, and other data to the system.

The term “importance level” refers to a quantitative or categorical measure that indicates how significant a piece of character information is within a given context of an information-distribution medium.

The term “relevance level” refers to a quantitative or categorical measure that indicates how closely a piece of character information is related to a specific topic, section, or purpose within an information-distribution medium.

The term “information-distribution medium” refers to any communication artifact used to convey information to a recipient, including but not limited to posters, newsletters, notices, advertisements, flyers, and digital signage content.

The term “information-distribution medium format” refers to a structural specification that defines sections, ordering, and constraints of content within an information-distribution medium, including title regions, body regions, image regions, and metadata regions.

The term “prompt sentence” refers to a machine-processable natural-language or semi-structured instruction string that conditions the behavior of a generative AI model for generating text, images, layout data, or other content.

The term “generative AI model” refers to a machine learning model, such as a neural network, that generates output data including text, images, or layout structures based on input prompt sentences and associated parameters.

The term “body data” refers to textual content that constitutes the main part of an information-distribution medium, including sentences, paragraphs, headings, and lists that express the substantive message.

The term “layout” refers to an arrangement specification that defines spatial positioning, size, alignment, and relationships among text elements, image elements, and other visual elements on a display region or print region.

The term “visual layout data” refers to machine-readable data describing a layout, including positions, dimensions, and ordering of text information, image information, and graphical elements for rendering or printing.

The term “template” refers to a predefined structural pattern or schema for arranging content in an information-distribution medium, including predefined regions and formatting rules that can be applied to different instances of content.

The term “text information” refers to content composed of character information intended for visual reading, such as titles, subtitles, body text, labels, and captions.

The term “image information” refers to content represented as pixel data or vector graphics, including photographs, illustrations, icons, and graphical symbols inserted into an information-distribution medium.

The term “image recognition processing” refers to computational analysis of image data using pattern recognition, machine learning, or computer vision techniques to detect, classify, or describe objects, scenes, or features in the image data.

The term “image candidates” refers to one or more image data items that are eligible for selection and insertion into an information-distribution medium based on content and visual balance.

The term “visual balance” refers to a visual design property indicating how evenly or harmoniously text elements, image elements, colors, and white space are distributed across a layout.

The term “event information” refers to structured or semi-structured data that describes an occurrence, including attributes such as name, date, time, location, and associated benefits or conditions.

The term “notification information” refers to structured or semi-structured data that describes an announcement, notice, or promotional message to be delivered to recipients.

The term “structured data” refers to data organized according to a predefined schema, such as key-value pairs, records, or objects, enabling deterministic parsing and transformation by the system.

The term “text-generation prompt sentence” refers to a prompt sentence specifically designed to cause a generative AI model to generate textual content, such as body data for an information-distribution medium.

The term “image-generation prompt sentence” refers to a prompt sentence specifically designed to cause a generative AI model to generate image content, such as a poster image or illustration.

The term “content data” refers to output data generated by a generative AI model, including but not limited to body data, images, or other media elements used in an information-distribution medium.

The term “terminal” refers to an endpoint device operated by a user, such as a mobile information terminal, tablet, personal computer, or other information processing terminal, that communicates with the server via a network.

The term “generation parameters” refers to one or more control values supplied to a generative AI model together with a prompt sentence, such as output size, style, temperature, number of outputs, or format options.

The term “interface of the generative AI model” refers to a communication endpoint, such as an application programming interface, by which the server transmits prompt sentences and generation parameters to the generative AI model and receives generated content data.

The term “input history” refers to recorded data describing past inputs provided by a user to the system, such as previously entered event information, notification information, or character information.

The term “viewing history” refers to recorded data describing which content or information-distribution media have been displayed to or accessed by a user or recipient, including times, durations, and interaction patterns.

The term “emotional state” refers to an estimated affective condition of a user or recipient, such as interest, satisfaction, boredom, or excitement, inferred from behavioral signals, sensor data, or model predictions.

The term “content elements” refers to constituent parts of an information-distribution medium, including textual segments, image segments, layout regions, and stylistic attributes that can be individually adjusted or selected.

The term “visual expressions” refers to visual characteristics used to express information, such as color schemes, font styles, graphical emphasis, iconography, and spatial emphasis patterns.

The term “print data” refers to device-independent or device-dependent data formatted for hard-copy output by a printing apparatus, including page size, resolution, color information, and layout instructions.

The term “electronic display data” refers to data formatted for display on an electronic device, such as a monitor, mobile screen, or digital signage, including resolution, orientation, and layout information.

The term “final output data” refers to data that is ready for direct use by a printing device or display device, derived from optimized visual layout data and content data, and representing a completed instance of an information-distribution medium.

In one embodiment, a server executes a content-generation program on a computing platform including at least one processor, a main memory, a non-volatile storage device, and a network interface. The server uses a general-purpose operating system such as a UNIX-like operating system, and the server executes application logic implemented, for example, in a programming language such as Python on a web framework such as a REST-type framework.

The server communicates with a generative AI model via an application programming interface provided over a communication network. The generative AI model is implemented on a separate computing infrastructure that includes one or more graphics processing units, high-bandwidth memory, and a model-serving environment.

The terminal is a user-operated device such as a smartphone, a tablet, or a personal computer that includes a display, a touch or pointing input device, a local processor, a memory, and a communication interface. The terminal executes either a browser rendering a web application or a native application, both of which provide a graphical user interface for inputting character information, event information, and notification information. The user operates the terminal to input text and select interface elements, and the terminal transmits structured data representing the input to the server.

The server stores program modules in the non-volatile storage device. The program modules include an input-analysis module, a prompt-generation module, a model-interface module, a layout-generation module, an image-selection module, a personalization module, an output-formatting module, and a data-management module. The server loads these modules into memory and executes them in cooperation with the processor.

The server uses the input-analysis module to parse character information received from the terminal. The server represents the character information in an internal data structure, for example, as token sequences and annotated records including fields such as “segment_id”, “text_string”, “source_field”, “importance_score”, and “relevance_score”. The server calculates importance and relevance scores by applying a scoring function that combines term-frequency statistics, position of the text in the input, semantic similarity measures, and rule-based weights tuned for an information-distribution medium format.

The server uses a text-vectorization component in the input-analysis module to convert each text segment into a numerical vector. The server may use a pre-trained embedding model, such as a neural network encoder, to obtain feature vectors. The server calculates semantic similarity using cosine similarity between vectors, and the server groups segments into clusters representing logical sections of an information-distribution medium such as a title section, a date/time section, a location section, and a benefits section. This transformation into structured, clustered records improves data management inside the server and allows deterministic control over which parts of the input are emphasized in later generative calls.

The server uses the prompt-generation module to construct a first prompt sentence that instructs text generation by the generative AI model. The server accesses the structured records produced by the input-analysis module and applies a template-filling algorithm in which predetermined phrasing is combined with extracted values. The server generates, for example, a prompt sentence such as:

“Based on the following structured information, generate body text for an information notice that is clear and concise. Title: Summer Sale. Date: August 1 to August 15. Location: special venue on the first floor. Benefit: 20% off all items. Use friendly language suitable for general customers.”

The server does not simply forward raw user text but instead performs a deterministic normalization and selection of fields, which reduces variance in model behavior and decreases the need for repetitive calls to the generative AI model.

The server uses the model-interface module to transmit the first prompt sentence to the generative AI model. The server prepares a request object that includes the prompt sentence, numerical generation parameters such as temperature, maximum token count, and top-p, and context identifiers. The server encodes this object as a message conforming to an application-level protocol and transmits the message over the communication network. The server then receives response data including generated text tokens and associated metadata. The generative AI model in one embodiment includes a transformer-based neural network with multiple attention layers and feed-forward blocks. The model has been trained according to a supervised or self-supervised learning procedure in which the model minimizes a cross-entropy loss between predicted tokens and ground-truth tokens on a large corpus of text. During training, the server or a training subsystem performs gradient-based optimization using stochastic gradient descent or a variant thereof, and the system updates model parameters by backpropagating error signals through the network. The system may employ data-augmentation techniques such as random masking and shuffling to increase robustness of the model.

The server, by using this transformer-based model through the model-interface module, obtains body data that is conditioned on the structured fields and on the specific prompt sentence patterns. Because the server constrains the prompt format and injects clearly labeled fields, the generative AI model can more reliably associate segments of output text with functional roles in the information-distribution medium, which improves precision and reduces unnecessary trial-and-error regenerations.

The server uses the layout-generation module to construct a second prompt sentence for layout guidance. The server analyzes the body data, identifies logical paragraphs, headings, and bullet points, and maps these elements to layout slots defined by a template description. The server represents layout slots as entries in a layout schema containing coordinates, size, and type (text region or image region). The server then constructs a second prompt sentence such as:

“Create a visually clear layout specification for a promotional poster using the following text. Treat the first line as the main headline, the second line as the date range, the third line as the location, and the remaining text as details. Provide a layout that can be mapped to an A3 vertical page with a large title area at the top, a medium area for date and location, and a lower area for details.”

The server may either submit this second prompt sentence to a text-based generative model to obtain a symbolic layout description, or the server may use deterministic rules combined with heuristic optimization (for example, minimizing overlap while maximizing text readability) to assign regions in a coordinate system for a display or print surface. The symbolic layout description is converted into visual layout data, for example, as a JSON-like internal representation with entries for positions, font sizes, and color categories.

The server uses the image-selection module to manage images inserted into the information-distribution medium. The server stores candidate images in an image repository together with metadata. The server applies an image-recognition pipeline to each candidate. The pipeline may include a convolutional neural network or a vision transformer that outputs feature vectors representing objects, scenes, and color distributions. The server clusters or classifies these features to tag images with labels such as “summer”, “sale”, “beach”, “family”, and color tone descriptors.

The server constructs a third prompt sentence when the server uses the generative AI model for image generation instead of or in addition to selection from a repository. For example, the server may construct:

“Generate a colorful promotional poster image for a ‘Summer Sale’ event occurring from August 1 to August 15 at a special venue on the first floor. Emphasize warm colors such as yellow and orange, include summer-themed icons, and reserve space at the bottom for the main text.”

The server selects between repository images and generated images based on resource constraints, quality requirements, or user preferences. The server aligns selected images with the layout schema by matching aspect ratios and resolving conflicts between image sizes and region sizes, thereby preventing rendering errors and improving final visual balance.

The server uses the personalization module to incorporate behavioral and emotional information into the prompt-generation pipeline. The server maintains a history data store that records, for each user or recipient, viewed content identifiers, interaction events, and optional feedback values. The server computes summary statistics such as frequency of viewing different types of campaigns, dwell times, and click-through rates. The server may also maintain an emotional-state estimation model that maps sequences of interaction events to discrete or continuous emotional labels. This model can be implemented as a recurrent neural network or a transformer that processes time-ordered event vectors and outputs an estimated probability distribution over emotional states.

The server uses these behavioral and emotional features as additional inputs when constructing prompt sentences. For example, the server may modify a first or second prompt sentence to include instructions such as “use more energetic language and brighter colors for recipients who previously engaged with high-contrast advertisements” or “reduce text density for recipients who quickly dismiss long texts.” These modifications are realized as deterministic string-manipulation operations that append or adjust clauses in the prompt sentence. As a result, the generative AI model is conditioned on user-specific context that is derived from quantified behavioral data, which is not feasible for a human operator to manually encode at scale.

The server uses the data-management module to periodically process recurring event information or notification information. The server maintains a structured representation of campaigns in a database, where each record includes fields such as campaign identifier, name, recurring schedule, date range, location, and discount parameters. The server executes a scheduler that checks for upcoming campaigns and updates field values according to time-based rules. When a campaign enters an active period, the server generates structured data for that campaign and triggers the same prompt-generation pipeline as for ad-hoc user input.

The server, by reusing structured data and templates, avoids reconstructing the entire content-generation process from unstructured inputs and thereby reduces computational overhead. The server can batch requests to the generative AI model by grouping multiple campaigns into a single call when compatible, which decreases communication overhead and improves throughput.

The server uses the output-formatting module to convert optimized visual layout data and content data into device-specific output formats. The server may generate vector-based documents, raster images with specific resolutions, or markup suitable for digital signage devices. The server encodes printing parameters such as page size, margins, and color profiles, and the server encodes display parameters such as pixel dimensions and orientation. The server transmits the final output data to the terminal or to a printing or display apparatus. The terminal receives the final output data and renders it on the display using a graphics engine or forwards it to a connected printer. The terminal may also store the data in local memory for offline use or re-display. The user views the rendered output, and the user may use hardware functions of the terminal, such as printing control, external display mirroring, or file sharing, to physically output or distribute the information-distribution medium.

In another embodiment, the server uses alternative neural network architectures for the generative AI model, such as diffusion-based models for image generation. In such an embodiment, the server passes the image-generation prompt sentence to a diffusion model that iteratively refines a noise tensor into an image tensor according to learned denoising steps. The model is trained using a loss function that measures discrepancy between noisy and clean images, and the server or training subsystem updates model parameters via gradient descent. This diffusion-based processing enables higher fidelity and more controllable imagery, particularly when used in combination with layout constraints encoded as additional conditioning vectors.

In yet another embodiment, the server implements rule-based post-processing of model outputs that deviates from conventional human workflows. The server applies non-standard heuristics such as penalizing overlong sentences by truncating or rephrasing them using a secondary constrained model, enforcing minimum font size thresholds based on reading distance estimates, or redistributing white space when density thresholds in particular layout regions are exceeded. These rules are implemented as algorithms operating on structured representations of text and layout, and they interact with model outputs in a way that optimizes readability and device suitability, rather than merely automating human editing steps.

The server, by coordinating these modules, achieves technical effects beyond simple automation of manual tasks. The server's transformation of raw character information into structured records, combined with standardized prompt-sentence formats and explicit layout schemas, reduces the entropy of inputs to the generative AI model and thus decreases variance in outputs. This in turn reduces the number of required regeneration cycles and network calls, improving processing speed and lowering communication load. The server's use of pre-computed embeddings, cluster structures, and behavior-based personalization further allows the system to cache intermediate computations and reuse them across sessions, which reduces processor load and memory usage.

The server's integration of image-recognition features with layout constraints permits automated, machine-level decisions about which images to select and how to place them, reducing layout errors such as cropped text or overlapping elements that would otherwise require manual correction. The causal relationship between structured processing and improved technical performance is that precise intermediate representations (structured data, layout schemas, feature vectors) constrain and guide subsequent computation in the generative AI model and in post-processing algorithms, thereby producing more predictable outputs and allowing optimizations such as batching, caching, and deterministic error handling.

Through these embodiments, the system improves the functioning of the computer environment by optimizing data structures, reducing redundant computation, coordinating network traffic to an external generative AI resource, and enabling automatic generation of device-ready output data without requiring human designers to manage low-level layout and asset integration steps.

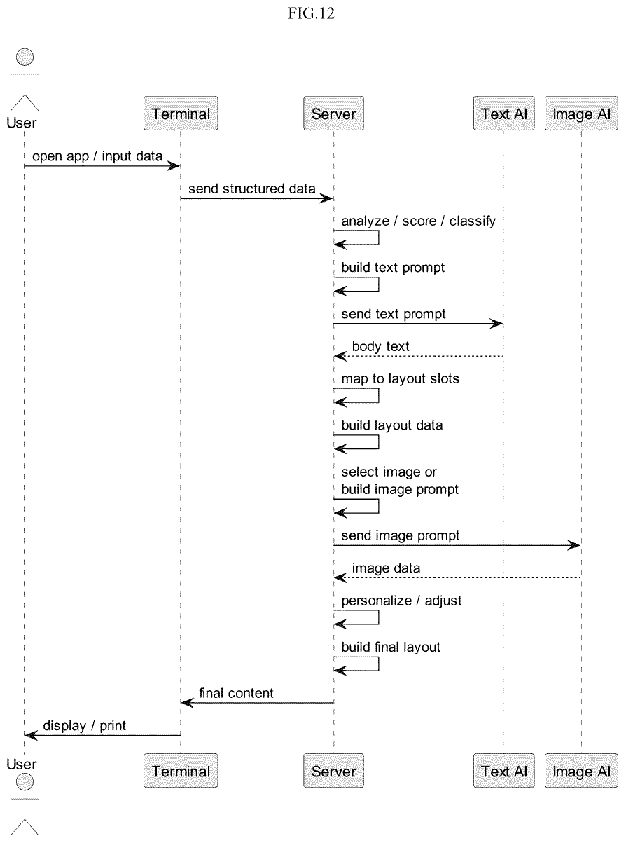

The following describes the processing flow using FIG. 12.

### Step 1:

The user operates the terminal and opens an application or web page that is connected to the server.

The terminal displays input fields for character information, event information, and notification information, such as title, date, time, location, and benefits.
Input: No structured data is present yet; only an initial user interface is shown.
Output: The terminal presents an empty input form and waits for user interaction.

### Step 2:

The user inputs text into the terminal by typing or touching the input fields and enters specific values, such as “Summer Sale”, “August 1 to August 15”, “Special venue on the first floor”, and “20% off all items”.

The terminal captures these values in local variables and associates each value with a field name.
Input: Raw keystrokes or touch events from the user.
Output: The terminal generates an internal representation of the input as key-value pairs (for example, title, date, location, benefit).

### Step 3:

The terminal validates the entered values locally by checking that all mandatory fields are filled and that the date and time formats conform to a predefined pattern.

The terminal, if necessary, displays error messages and requests correction when validation fails.
Input: The key-value pairs representing user input.
Output: A validated set of key-value pairs, or a validation-error state that remains on the terminal until corrected by the user.

### Step 4:

The terminal converts the validated key-value pairs into structured data, such as a record containing labeled fields for title, date, time, location, and benefits.

The terminal encapsulates this structured data into a message suitable for transmission over a network.
Input: Validated key-value pairs.
Output: A structured data object that can be serialized for network transmission.

### Step 5:

The terminal transmits the structured data to the server via a communication network using a request message, and the terminal records a transmission timestamp.

The terminal waits for a response from the server while maintaining a reference to the request.
Input: The structured data object created in Step 4.
Output: A network request sent to the server, and an internal pending-request state in the terminal.

### Step 6:

The server receives the request message through a network interface and passes the message to an input-analysis module.

The server deserializes the structured data into an internal data structure that includes fields such as “title_text”, “date_text”, “location_text”, and “benefit_text”.
Input: The serialized structured data received from the terminal.
Output: An in-memory structured record representing user input.

### Step 7:

The server analyzes the structured record and splits each field into text segments, such as individual sentences or phrases.

The server assigns segment identifiers and constructs a list or array of segments for further processing.
Input: The structured record with field-level strings.
Output: A list of text segments, each associated with metadata such as segment_id and source_field.

### Step 8:

The server computes importance and relevance scores for each text segment by applying a scoring function based on factors such as term frequency, presence of keywords, and position in the input.

The server may also compute semantic similarity features by applying a text-embedding model to each segment and calculating distances between segments.
Input: The list of text segments and associated metadata.
Output: An enriched list of segments where each segment has importance_score and relevance_score values.

### Step 9:

The server classifies the segments into logical categories of an information-distribution medium, such as headline, sub-headline, date region, location region, and detail region, by using the scores and, optionally, rule-based mappings.

The server stores the classification result in a structured representation of the information-distribution medium format.
Input: The segments with importance and relevance scores.
Output: A formatted structure that maps segments to predefined regions of an information-distribution medium.

### Step 10:

The server constructs a first prompt sentence to generate body text by selecting segments according to their classifications and inserting their values into a predefined language template.

The server, for example, generates a first prompt sentence such as:

“Based on the following structured information, generate body text for an information notice that is clear and concise. Title: Summer Sale. Date: August 1 to August 15. Location: special venue on the first floor. Benefit: 20% off all items. Use friendly language suitable for general customers.”
Input: The formatted structure that maps segments to medium regions.
Output: A first prompt sentence prepared for input to a generative AI model.

### Step 11:

The server uses a model-interface module to send the first prompt sentence, along with generation parameters such as maximum token count and temperature, to a generative AI model.

The server encapsulates the prompt sentence and parameters into a request and transmits the request to the model-serving infrastructure over a network.
Input: The first prompt sentence and associated generation parameters.
Output: A model-request message sent to the generative AI model.

### Step 12:

The generative AI model processes the request by tokenizing the prompt sentence, feeding the tokens into a transformer-based neural network, and computing output token probabilities by performing matrix multiplications and non-linear transformations in stacked layers.

The server receives the resulting sequence of tokens and reconstructs the body text for the information-distribution medium when the model responds.
Input: The first prompt sentence and generation parameters received by the model.
Output: Generated body data for the information-distribution medium returned to the server.

### Step 13:

The server parses the generated body data and identifies logical units such as title line, date line, location line, and detail paragraphs by applying pattern recognition and rule matching on the text.

The server assigns these logical units to layout slots and prepares a symbolic representation of how content should be positioned.
Input: The body text returned from the generative AI model.
Output: A mapping between logical text units and abstract layout slots.

### Step 14:

The server constructs a second prompt sentence for layout guidance when the server uses an additional generative AI model for layout specification.

The server can, for example, generate a second prompt sentence such as:

“Create a visually clear layout specification for a promotional poster using the following text. Treat the first line as the main headline, the second line as the date range, the third line as the location, and the remaining text as details. Provide a layout that can be mapped to an A3 vertical page with a large title area at the top, a medium area for date and location, and a lower area for details.”
Input: The mapping between logical text units and layout slots.
Output: A second prompt sentence that expresses layout constraints and roles of text units.

### Step 15:

The server either sends the second prompt sentence to a generative AI model that outputs a symbolic layout, or the server applies deterministic layout rules that assign coordinates and sizes to each slot based on a template.

The server converts the resulting layout description into visual layout data, such as a structured list of regions with attributes for position, dimensions, font size, and alignment.
Input: The second prompt sentence or the logical mapping and template rules.
Output: Machine-readable visual layout data suitable for rendering or printing.

### Step 16:

The server accesses an image repository and retrieves candidate images that match general criteria for the information-distribution medium, such as theme or campaign type.

The server applies image-recognition processing to each candidate image by passing image data through a neural network that outputs feature vectors indicating detected objects, scenes, and color distributions.
Input: A set of candidate images relevant to the campaign.
Output: A set of annotated images, each with associated feature vectors and tags.

### Step 17:

The server matches annotations of candidate images with semantic features of the body data and with layout constraints, such as available image region size and aspect ratio.

The server selects one or more images that best align with the campaign theme and the visual balance requirements.
Input: Annotated candidate images and semantic features of the text.
Output: A selected image or a ranked list of images that fit the layout.

### Step 18:

The server constructs a third prompt sentence when image generation by a generative AI model is required, such as:

“Generate a colorful promotional poster image for a ‘Summer Sale’ event occurring from August 1 to August 15 at a special venue on the first floor. Emphasize warm colors such as yellow and orange, include summer-themed icons, and reserve space at the bottom for the main text.”

The server then transmits this prompt sentence and image-generation parameters, such as resolution and style, to an image-generation model.
Input: Campaign-level structured data and layout constraints.
Output: A third prompt sentence and a request to the image-generation model.

### Step 19:

The generative AI model for images generates an image by applying a neural-network-based algorithm, such as a diffusion process or a convolutional architecture, to transform noise into a coherent image conditioned on the prompt.

The server receives the generated image data, decodes any encoded representation, and stores the image in an internal buffer or image store.
Input: The third prompt sentence and image-generation parameters received by the model.
Output: Generated image data available to the server.

### Step 20:

The server integrates the selected or generated image into the visual layout data by assigning the image to predefined regions and adjusting scaling to fit the allocated space while preserving aspect ratio.

The server updates the visual layout data to include references to the image resource along with placement information.
Input: The visual layout data and image data selected or generated in previous steps.
Output: Composite layout data that includes both text and image placement.

### Step 21:

The server retrieves behavioral and viewing history data for the relevant user or recipient from a history data store, including past interactions and, if available, emotional-state estimations.

The server computes summary metrics, such as frequency of engagement with particular color themes or text densities.
Input: Historical interaction records and optional emotional-state estimations.
Output: A set of personalization features describing user preferences and tendencies.

### Step 22:

The server uses the personalization features to adjust prompt sentences or layout parameters.

The server may construct a fourth prompt sentence that includes instructions such as “use energetic and concise language and brighter colors” for highly engaged recipients, or “simplify the layout and increase font size” for users who quickly dismiss dense materials.
Input: Personalization features and existing prompt or layout data.
Output: Modified prompt sentences and updated layout constraints that reflect personalization.

### Step 23:

The server regenerates or refines body data, layout data, or image requests according to the modified prompt sentences when necessary to match the personalization constraints.

The server calls the generative AI model again only for the portions that require adjustment, thereby avoiding full recomputation.
Input: Modified prompt sentences and existing content artifacts.
Output: Updated sections of text, layout, or imagery that satisfy personalization requirements.

### Step 24:

The server assembles optimized visual layout data and content data into output-ready formats.

The server converts the internal representation into formats suitable for printers or displays, such as a high-resolution raster image, a vector document, or a structured markup document.
Input: Composite layout data containing text and images.
Output: Device-specific output data for print or electronic display.

### Step 25:

The server transmits the final output data to the terminal over the network and records the transmission in the data-management module for logging and audit purposes.

The server may also store a copy of the output data in persistent storage for later reuse or re-distribution.
Input: The device-specific output data generated in Step 24.
Output: A response message sent to the terminal containing the final visual content.

### Step 26:

The terminal receives the response message from the server and extracts the output data.

The terminal renders the content on the display or passes the content to a printing subsystem or an external display device according to user settings.
Input: The final output data received from the server.
Output: A rendered image or document visible on the terminal or physically printed by a printer.

### Step 27:

The user views the rendered information-distribution medium on the terminal and decides whether to store, print, or share it.

The user may initiate additional actions, such as saving the file locally, sending it via a communication application, or displaying it on a digital signage device, thereby applying the generated content in a real-world environment.
Input: The rendered content presented on the terminal screen.
Output: User actions that lead to physical output or further digital dissemination of the generated medium.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for creating classroom bulletins and similar structured documents rely heavily on manually authored templates and rigid rule-based engines. In such systems, a computing device typically provides fixed input forms and static layout patterns, and the processor arranges user-entered text and images according to predetermined positions. These approaches exhibit several technical limitations in terms of information processing efficiency, flexibility of layout generation, and the ability of the computing system to adapt its behavior to heterogeneous, unstructured inputs.

First, conventional systems treat user input as largely unstructured text and do not perform fine-grained, machine-assisted structuring of semantic elements such as dates, events, notices, and priorities. As a result, the processor cannot exploit the full expressive power of statistical or generative models to reorder content, allocate display resources, or automatically manage recurring information. The lack of systematic structuring and prioritization of information forces the user or designer to repeatedly perform manual editing operations and layout adjustments, which increases processing latency, consumes more computational and communication resources due to repeated trial-and-error cycles, and impedes the scalability of the system to a large number of bulletins or users.

Second, existing document generation systems either do not employ generative models or employ them in an ad hoc way, merely as black-box text generators. In such systems, prompt sentences are not generated in a structured, programmatic manner from machine-readable data representations, and the generated outputs are not systematically re-integrated into a data model that drives subsequent processing stages. This leads to non-deterministic behavior and unpredictable document structures, which in turn complicates downstream layout processing and limits the ability of the system to perform automated optimization of page position, area allocation, and image selection. The absence of a controlled interaction loop between structured data, prompt construction, and generative AI model output diminishes the technical reliability and traceability of the whole pipeline.

Third, many conventional systems treat images and illustrations as static resources that are manually selected and placed by users. They typically lack integrated image recognition pipelines to automatically analyze multiple candidate photographs according to machine-computable criteria such as number of persons visible, image quality, composition, and balance. Similarly, these systems do not automatically generate visual elements such as icons or illustrations that are semantically aligned with specific content units in the text (e.g., belongings lists, seasonal events, safety notices). Consequently, the processor cannot automatically optimize the visual balance between text and images in a way that reflects content importance and semantic relationships, leading to suboptimal information density per page and increased cognitive load on end users.

Fourth, conventional systems handle recurring or periodic events (such as monthly meetings or seasonal activities) using manually updated templates or fixed date rules embedded in program code. They do not centrally maintain structured, machine-readable representations of past bulletins that can be programmatically scanned and updated by the processor according to configurable updating rules. This inhibits reuse of historical data, forces repeated manual data entry, and leads to inconsistencies across generated bulletins. The computing resources of the system are therefore not efficiently leveraged to automate regular content updates and to reduce redundant write operations and processing steps.

Fifth, existing layout engines generally focus on low-level rendering operations, such as flowing text into frames and rasterizing pages, and do not integrate high-level content prioritization based on quantified measures of importance and relevance. In other words, the layout engine is not guided by scores that reflect semantic importance or expected interest of recipients, and hence lacks a mechanism for algorithmic allocation of space, font emphasis, and placement order on the basis of machine-calculated priorities. This limitation prevents the system from algorithmically optimizing the document structure in response to content characteristics, which is a concrete technical inefficiency in the way the computing system performs layout computation.

Furthermore, existing systems typically do not maintain a unified, data-driven pipeline that begins with unstructured user input, passes through semantic structuring, priority scoring, generative AI text and image production via prompt sentences, and culminates in a layout engine driven by these structured artifacts. In the absence of such an integrated pipeline, the processor must repeatedly move data between incompatible representations (e.g., raw text, partially formatted text, and separate layout instructions), causing redundant parsing, ad hoc transformations, and increased memory transfers. These operations increase computing overhead, lead to inconsistency between text and images, and make it difficult to reason about or improve the end-to-end behavior of the system.

Accordingly, there is a need for an improved computer-implemented system that technically enhances the way a processor acquires, structures, and prioritizes user-provided information; programmatically generates and uses prompt sentences to interact with generative AI models; automatically generates and selects visual elements based on content semantics and image recognition; updates recurring content by operating on structured, machine-readable records; and generates layout data that optimizes page structure, font emphasis, and image placement according to computed priority scores. Such a system should reduce manual intervention, minimize redundant processing and data transfers, and enable the computing device to produce optimized, consistent documents with lower computational overhead and improved adaptability to unstructured input data.

The specific processing by the specific processing unit 290 of the data processing device 12 in Example 2 is realized by the following means.

The present invention provides a server comprising a processor and a storage device, wherein the processor is configured to execute computer-implemented operations including: acquiring character information and image information input by a user via a terminal over a communication network and storing the character information and the image information in the storage device; analyzing the character information by natural language processing to extract structured information including date information, event information, notice information, and other attribute information, quantifying importance and relevance of each piece of the structured information, classifying the structured information based on the quantified importance and relevance, and storing a result of the classification in the storage device; rearranging the structured information stored in the storage device so as to conform to a document format of a class bulletin, generating a prompt sentence including the rearranged structured information as input data, and inputting the prompt sentence into a generative information processing model to cause the generative information processing model to generate candidate text of a body of the class bulletin; acquiring past structured information stored in the storage device, identifying structured information relating to periodically occurring events, automatically updating the structured information relating to the periodically occurring events based on a predetermined update rule, and using updated structured information in generation of the candidate text of the body of the class bulletin; analyzing the candidate text of the body of the class bulletin and the structured information to determine a document structure including headings, body portions, and list portions according to a predetermined template, generating, for each information unit to be included in the class bulletin, a prompt sentence to be input into the generative information processing model, and inputting the prompt sentence into the generative information processing model to cause the generative information processing model to generate text of the body of the class bulletin; analyzing the text of the body of the class bulletin and the structured information to identify information units to which visual elements are to be added, the information units including at least a belongings list, a seasonal event, and a safety notice, generating, for each of the information units, a prompt sentence for image generation, inputting the prompt sentence for image generation into an image generative information processing model to cause the image generative information processing model to generate the visual elements, and storing the visual elements in association with corresponding information units in the storage device; analyzing a plurality of photograph data uploaded from the terminal by image recognition processing, scoring the plurality of photograph data based on at least a number of persons, an image quality, a composition, and a presence or absence of bias, selecting candidate photographs to be inserted into the class bulletin based on a result of the scoring, and storing a selection result of the candidate photographs in the storage device; determining a priority for each information unit based on the text of the body of the class bulletin, the visual elements, the candidate photographs, the structured information corresponding to the text of the body of the class bulletin, the visual elements, and the candidate photographs, and the quantified importance and relevance, generating layout data by automatically optimizing, according to the determined priority, at least a page position, an area size, character decoration, and image placement, and generating a visual layout in which character information and image information are combined based on the layout data; and generating final output data in at least one of a print data format and an electronic display data format based on the layout data and the text of the body of the class bulletin, and transmitting the final output data to the terminal. This enables the computing system to transform unstructured user input into priority-scored structured data, to control generative AI models through programmatically constructed prompt sentences, to integrate AI-generated text and visual elements into layout data that reflect quantified importance and semantic relationships, and to produce optimized, machine-generated documents with reduced manual intervention, improved processing efficiency, and enhanced adaptability compared to conventional rule-based or template-only systems.

The term “system” refers to an arrangement of hardware and software components including at least a processor, a storage device, and a communication interface, which cooperate to execute the claimed operations.

The term “processor” refers to a hardware processing unit or a combination of hardware processing units, such as a central processing unit or a graphics processing unit, that executes instructions to perform arithmetic, logic, control, and input/output operations.

The term “storage device” refers to a hardware memory component or a combination of hardware memory components, such as a semiconductor memory, a magnetic storage medium, or an optical storage medium, configured to store data and programs persistently or temporarily.

The term “terminal” refers to an information processing device operated by a user, such as a personal computer, a tablet device, or a mobile communication device, that transmits input data to the system and receives output data from the system.

The term “character information” refers to data representing symbols, letters, numerals, punctuation marks, or other text characters, including user-entered sentences, words, and labels.

The term “image information” refers to data representing visual content, including still images, photographs, icons, illustrations, and graphical elements encoded in digital image formats.

The term “class bulletin” refers to a structured document intended to communicate educational class-related information, such as events, schedules, notices, and reminders, to recipients including students, guardians, or related parties.

The term “natural language processing” refers to a computational technique for analyzing and processing human language text by operations such as tokenization, part-of-speech tagging, entity extraction, and semantic analysis.

The term “structured information” refers to information that has been converted from unstructured text into a formal representation with defined fields or attributes, such as date fields, event fields, and notice fields, that can be programmatically processed.

The term “date information” refers to structured information that represents temporal data, including a year, month, day, and optionally a time or time range associated with an event.

The term “event information” refers to structured information that represents an occurrence or activity, including at least a name, a description, and optionally a location and schedule. The term “notice information” refers to structured information that represents messages, instructions, or alerts to recipients, including warnings, reminders, and requests.

The term “attribute information” refers to structured information other than date information, event information, and notice information, including labels, categories, identifiers, and other descriptive metadata.

The term “importance” refers to a quantitative or qualitative measure indicating how critical or essential a piece of structured information is relative to other pieces of information in a document.

The term “relevance” refers to a quantitative or qualitative measure indicating a degree of relationship or pertinence between a piece of structured information and a specified context, topic, or recipient.

The term “classification” refers to the process of assigning one or more categories, groups, or priority levels to pieces of structured information based on quantified importance and relevance.

The term “document format” refers to a predefined structural specification for arranging content in a document, including sections, headings, paragraphs, lists, and pagination rules. The term “prompt sentence” refers to a text string configured as an instruction or query, optionally including structured data, that is input to a generative information processing model to control or influence its output.

The term “generative information processing model” refers to a trained computational model that receives input data including a prompt sentence and produces generated output data, such as text or other content, using probabilistic or neural network-based techniques.

The term “candidate text of a body of the class bulletin” refers to a preliminary version of main textual content generated by the generative information processing model before final selection, adjustment, or layout processing.

The term “periodically occurring events” refers to events that repeat according to a temporal pattern, such as daily, weekly, monthly, or seasonal occurrences.

The term “update rule” refers to a set of predefined conditions and operations for modifying structured information, including operations such as shifting dates, adjusting descriptions, or reassigning categories.

The term “document structure” refers to an arrangement of textual components within a document, including headings, body portions, list portions, subsections, and their hierarchical relationships.

The term “information unit” refers to a logically coherent subset of content, such as a single event description, a notice, a list, or a textual paragraph, that can be individually processed and rendered.

The term “visual element” refers to a non-textual graphical component, such as an icon, illustration, or decorative symbol, that is associated with an information unit to improve visual clarity or emphasis.

The term “belongings list” refers to a type of information unit that enumerates items or equipment that recipients or related persons are requested to prepare or bring.

The term “seasonal event” refers to an event occurring in association with a particular season or period of the year, such as an excursion, festival, or term-specific activity.

The term “safety notice” refers to a type of notice information that conveys safety-related instructions, precautions, or warnings.

The term “image generative information processing model” refers to a generative information processing model that receives input data including a prompt sentence and generates image information such as icons or illustrations.

The term “photograph data” refers to image information acquired by an image capturing device and representing real-world scenes, including pictures of persons, locations, and activities.

The term “image recognition processing” refers to a computational technique for analyzing image information to identify features such as objects, persons, faces, or patterns.

The term “number of persons” refers to a count of distinct persons detected in photograph data by image recognition processing.

The term “image quality” refers to a measure of visual fidelity of image information, including aspects such as resolution, sharpness, brightness, and absence of artifacts.

The term “composition” refers to an arrangement of visual elements within image information, including framing, balance, and spatial distribution of subjects.

The term “bias” refers to an imbalance or disproportionate representation in photograph data, such as overrepresentation of specific persons or underrepresentation of a group, as determined by image recognition processing.

The term “candidate photographs” refers to a subset of photograph data selected from multiple photographs based on scoring criteria for potential insertion into a document.

The term “priority” refers to a relative ranking or ordering assigned to information units for controlling their placement, emphasis, or space allocation in a layout.

The term “layout data” refers to machine-readable data that specifies positioning, sizing, and styling of text and images in a document, including page coordinates, region dimensions, font settings, and image frame definitions.

The term “page position” refers to a location specified in a page coordinate system where an information unit or visual element is to be placed.

The term “area size” refers to a spatial extent or bounding region allocated to an information unit, text block, or image in a layout.

The term “character decoration” refers to visual styling applied to text, including font type, font size, weight, color, underlining, and other typographic effects.

The term “image placement” refers to the determination of the position, size, and orientation of an image within a layout.

The term “visual layout” refers to a rendered or renderable arrangement in which character information and image information are combined according to layout data to form one or more pages of a document.

The term “final output data” refers to data in a format suitable for distribution or display, including at least print-ready data formats and electronic display data formats.

The term “print data format” refers to a data format configured for physical printing, including page description formats and other printable document formats.

The term “electronic display data format” refers to a data format configured for presentation on an electronic display device, including formats interpreted by web browsers or document viewer applications.

The term “viewing information” refers to data indicating how recipients have accessed or viewed previous documents, including access logs, viewing durations, and page navigation records.

The term “selection information” refers to data indicating recipients' explicit or implicit choices or interactions with content, such as item selections, clicks, or taps.

The term “response information” refers to data representing recipients' feedback or answers, including survey responses, ratings, and free-text comments.

The term “recipients” refers to persons or entities intended to receive or view the class bulletin, such as students, guardians, or other stakeholders.

The term “interest level” refers to a measure, inferred or calculated from past behavior or responses, that indicates how likely a recipient is to find a particular information unit engaging or relevant.

In one embodiment, a server cooperates with a plurality of terminals operated by users to implement the claimed system. The server includes at least one processor, a main memory, a non-volatile storage device, and a network interface. The processor may be a general-purpose central processing unit, a graphics processing unit, or a combination thereof. The storage device may be a magnetic disk, a solid-state drive, or a network-attached storage. The network interface connects the server to the terminals via a communication network such as the Internet or a local area network.

The terminal is an information processing device such as a personal computer, a tablet, or a smartphone. The terminal executes a web browser or a dedicated client application and communicates with the server by using a network protocol such as HTTP over TLS. The terminal provides graphical user interface components including text fields, calendar widgets, icons, buttons, and file selection controls. The terminal accepts user input via a pointing device, a touch screen, or a keyboard and transmits character information and image information to the server.

The server executes an application program implemented, for example, using a web framework, a database management system, and client-server communication modules. The server uses middleware such as an HTTP server and an application server to receive and respond to requests from the terminals. The server uses a relational database to store structured information. The relational database defines tables such as USERS, NEWSLETTERS, EVENTS, NOTICES, SECTIONS, PHOTOS, and ILLUSTRATIONS. Each table has primary keys and foreign keys that relate text content, structured fields, and visual elements.

The server analyzes character information by using a natural language processing library that runs on the processor. In one embodiment, the server tokenizes the character information, performs part-of-speech tagging, and identifies named entities such as dates, locations, and person names. The server uses a rule-based parser and a statistical model to map tokens to fields such as date information, event information, notice information, and attribute information. The server stores the extracted structured information as records in the database, for example in the EVENTS table with columns including EVENT_ID, TITLE, DATE, TIME, LOCATION, and PRIORITY_SCORE.

The server computes an importance score and a relevance score for each piece of structured information. In one embodiment, the server uses a feature vector that includes term frequency values, the presence of keywords indicating urgency, the length of the text segment, and the position of the segment in the original input. The server applies a trained classifier that outputs a numerical score for importance and a numerical score for relevance. The classifier may be implemented as a feed-forward neural network with multiple fully connected layers and activation functions such as rectified linear units. The server stores these scores as fields in the database.

The server constructs a prompt sentence for a generative AI model by programmatically combining fixed instruction text with structured information retrieved from the database. The server embeds section headings, dates, events, and notices in the prompt sentence in a consistent order. For example, the server may generate a prompt sentence such as: “Using the following structured data about class events and notices, write a complete class newsletter for parents. Use friendly, polite language and include headings and bullet points.

### Events:

2026-10-10, Autumn field trip to the city museum, departure at 9:00, return at 15:00, students should bring lunch, water bottle, and a light jacket.
2026-10-25, Monthly parent-teacher meeting, starts at 18:30 in Classroom 3A.

### Notices:

Please label all children's belongings with their names.
If your child has allergies, contact the teacher in advance.”

The server transmits the prompt sentence to a generative AI model via an application programming interface. In one embodiment, the generative AI model is implemented as a transformer-based neural network that has multiple encoder-decoder layers, multi-head attention mechanisms, and positional encodings. The server passes tokenized prompt data and model configuration parameters such as maximum output length and temperature. The generative AI model generates candidate text of a body of a class bulletin by computing attention-weighted sums of token embeddings and by iteratively predicting the next token based on previous outputs. The server receives the generated tokens from the generative AI model, decodes them into text, and stores the candidate text in the NEWSLETTERS table as a draft field.

The server identifies structured information that corresponds to periodically occurring events by querying the database. The server compares event titles, labels, and categories across multiple existing newsletter records and detects recurring patterns. The server applies update rules that shift dates, update month names, and adjust day-of-week constraints. Because the server stores the data as structured records, the server modifies only the relevant fields without re-parsing raw text. This reduces parsing errors and computing overhead.

The server further refines the document structure by segmenting the candidate text into information units. The server analyzes sentence boundaries and paragraph breaks and uses pattern matching to detect section titles and list items. The server stores each information unit as a separate record in the SECTIONS table and associates it with an event or notice via foreign keys. For each information unit, the server can generate an additional prompt sentence for localized rewrite operations. For example, the server may generate a prompt sentence such as:

“Revise only the section about the October 10 museum field trip. Emphasize departure and return times, required items (lunch, water bottle, light jacket), and a short safety note. Keep the tone consistent with the rest of the newsletter.”

In this way, the server controls the generative AI model at a fine-grained level and avoids regenerating the entire document when a partial change is needed. This selective regeneration reduces network traffic and computational resources, and thus improves processing efficiency.

The server generates visual elements by controlling an image generative AI model. The server analyzes structured information and candidate text to detect information units that benefit from visual support, such as belongings lists, seasonal events, and safety notices. When the server detects a belongings list, the server constructs a prompt sentence such as: “Create a simple, colorful illustration for an elementary school newsletter showing a checklist of items: lunch box, water bottle, light jacket, and comfortable shoes.”

The server sends this prompt sentence to the image generative AI model. The image generative AI model may be implemented as a diffusion model or a generative adversarial network. In one embodiment, the diffusion model starts from random noise and iteratively denoises the image according to learned parameters that map textual embeddings to intermediate image representations. The server receives a raster image, encodes metadata such as resolution and color depth, and stores a URL or a file path to the image in the ILLUSTRATIONS table.

The server processes photograph data uploaded from the terminal by applying an image recognition algorithm. The server uses a convolutional neural network trained to detect faces, count persons, and evaluate image quality. The server computes feature maps at multiple scales by applying convolution, pooling, and activation operations to the input image. The server uses the resulting feature vectors to classify whether an image is acceptable and to estimate the number of persons visible. The server assigns a score to each photograph based on the number of persons, the sharpness of edges, the exposure level, and the balance of subjects across the frame. The server stores these scores and selection flags in the PHOTOS table.

The server determines priorities for information units by combining importance scores, relevance scores, and image-related scores. The server uses a multi-criteria scoring function that outputs a priority value for each information unit. The priority value is computed by taking a weighted sum of normalized scores, where the weights are stored in configuration data. The server then uses these priority values to generate layout data. In one embodiment, the server defines a page grid as a set of rectangular regions represented as coordinates. The server assigns high-priority information units to top regions and middle regions of the first page and assigns lower-priority units to smaller regions or subsequent pages.

The server generates layout data as a machine-readable structure that specifies page positions, area sizes, character decorations, and image placements. The server stores coordinates, dimensions, font names, font sizes, and image frame positions in layout records. The server then passes the layout data and the body text to a layout engine. In one embodiment, the server uses a document rendering library that converts layout data and text into a page description language or a portable document format. The server instructs the layout engine to flow text into frames and to position images at coordinates specified in the layout data.

The terminal receives a uniform resource locator or a binary representation of the final output data from the server. The terminal displays the class bulletin on a screen for preview and may send print commands to a printing device. Because the server has optimized layout based on priorities and structural analysis, the bulletin contains clearly emphasized important information, and images are placed near relevant text segments. As a result, the visual clarity and information density of the output document are improved.

In another embodiment, the server provides a user interface control to allow the user to perform corrections on specific sections. The user may modify text content, disable certain images, or adjust emphasis flags via the terminal. The terminal transmits the modifications as structured change requests. The server updates the relevant rows in the database tables and triggers localized regeneration or re-layout as needed. The server does not discard the entire document, but instead merges the modified content with existing layout data, which reduces computational waste.

The server uses error functions and training methods to improve the models used in the system. During an offline training phase, the server (or a separate training system) trains the neural network models used for importance scoring, event classification, and image recognition. The server minimizes loss functions such as cross-entropy loss for classification tasks and mean squared error for regression tasks. The server updates weights using an optimization algorithm such as stochastic gradient descent or an adaptive optimization method. The server can perform data augmentation, such as random cropping, rotation, or brightness adjustment on images, and synonym replacement or paraphrasing on text, to improve model generalization.

The server applies model outputs in a deterministic pipeline. The server does not rely on manual layout editing; instead, the server defines programmatic rules that map predicted importance scores and classifications to explicit layout operations. This mapping is different from conventional human layout design, which is often subjective and not reproducible. The server executes the pipeline consistently for different inputs, thereby producing reproducible and traceable document structures.

From a technical standpoint, the system improves computer functionality in several ways. The server reduces redundant text parsing and layout recomputation by storing structured information and by regenerating only affected portions of the document when changes occur. This reduces CPU usage and memory transfers. The server reduces network communication between the terminal and the server by controlling generative AI models on the server side and by exchanging compact representations such as structured records and prompt sentences instead of transferring entire intermediate documents. The server increases accuracy of image selection by using machine-learned scoring instead of simple resolution thresholds, which improves the quality of generated bulletins and reduces the need for user-initiated re-uploads. The server also improves data management by representing document content as normalized database records, enabling efficient queries, reuse of recurring events, and automated updates without re-entry by the user.

In addition, the system uses a non-conventional sequence of operations that differs from straightforward automation of human authoring. The server first structures input data, then computes quantitative priorities, then generates prompt sentences that reference the structured data, then invokes generative AI models to produce text and images, and finally drives a layout engine using layout data derived from the priorities. This particular ordering of operations allows the server to perform optimization of layout and content at the data-structure level rather than at the level of final pages. This design reduces computational complexity, because the server can perform search and sorting on compact structured representations instead of on large rendered page images.

In an alternative embodiment, the server can employ different generative AI models or different neural network architectures for importance scoring, text generation, and image generation. The server may use a smaller transformer model for local section rewriting, and a larger transformer model for initial full-document generation. The server may also use a separate attention-based network that takes as input the structured information and outputs section ordering and grouping decisions. The system architecture can be adapted to various document types beyond class bulletins, such as newsletters, reports, and manuals, by modifying the structured fields, templates, and prompt sentences. In each case, the server still uses the same technical mechanism of structured data extraction, priority-based layout generation, and programmatic control of generative AI models via prompt sentences to improve computing efficiency and output quality.

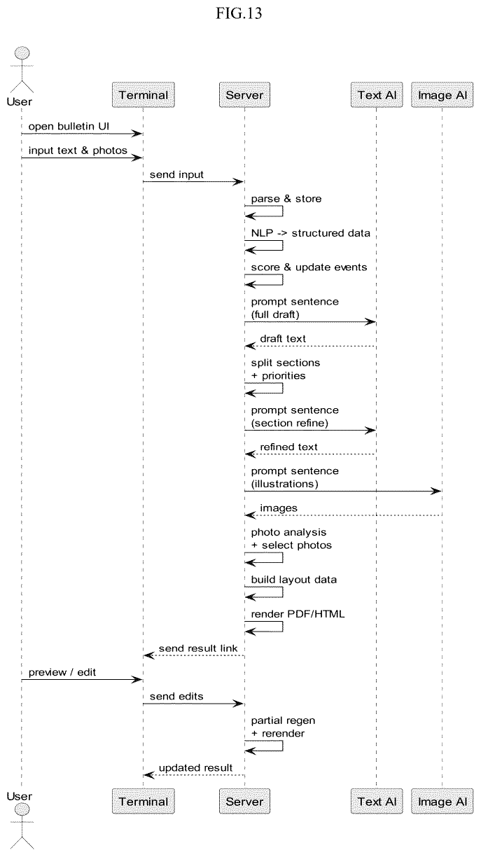

The following describes the processing flow using FIG. 13.

### Step 1:

The user operates the terminal to open a class bulletin creation screen and enters character information and image information.
Input: The user provides raw text (event dates, titles, descriptions, notices) via text fields and selects or uploads photographs from local storage or a camera.
Processing: The terminal validates basic formats (for example, checking that date fields match a date pattern and that required fields are not empty), converts the input into a request payload, and attaches metadata such as user ID and device timestamp.
Output: The terminal generates a structured request containing the character information, image information, and metadata, and transmits the request to the server over a network connection.

### Step 2:

The server receives the request and stores the raw input data into a storage device.
Input: The server accepts an HTTP request (or equivalent) containing JSON-formatted character information, binary image data or image references, and user metadata.
Processing: The server parses the request body, decodes character encodings, verifies integrity of the image files, and creates new records in tables such as NEWSLETTERS, EVENTS, NOTICES, and PHOTOS. The server assigns unique identifiers (for example, newsletter ID, event ID) using an ID generation routine and writes the raw text and file paths into the storage device.
Output: The server produces persistent database entries representing the initial, unstructured bulletin content, and returns an acknowledgment to the terminal if needed.

### Step 3:

The server performs natural language processing to convert the character information into structured information.
Input: The server retrieves raw character information for a target newsletter record from the storage device.
Processing: The server tokenizes the text, applies part-of-speech tagging, and runs named entity recognition to detect dates, times, locations, and key phrases. The server maps detected entities into predefined fields (date information, event information, notice information, attribute information) using rule-based mapping and statistical classification. The server computes feature vectors for each segment (for example, presence of temporal expressions, action verbs, and imperative forms) and classifies the segments as events or notices.
Output: The server generates structured information objects containing normalized fields (such as a date in YYYY-MM-DD format, a title string, a description string, and a location string) and stores these structured records in database tables such as EVENTS and NOTICES.

### Step 4:

The server calculates importance and relevance scores for each piece of structured information.
Input: The server loads structured information records and associated text segments from the database.
Processing: The server constructs feature vectors that include term frequencies, keyword flags (for words like “must,” “deadline,” “important”), segment length, and correlations with past user engagement statistics if available. The server applies a trained neural network classifier or regression model to these feature vectors to compute continuous-valued importance and relevance scores.
Output: The server outputs updated structured information records with additional numeric fields for importance and relevance and writes these scores into corresponding database columns.

### Step 5:

The server identifies and updates structured information relating to periodically occurring events.
Input: The server queries past structured information records for events flagged as recurring or matching specific titles and categories.
Processing: The server compares event names and tags across multiple past newsletters, applies string similarity metrics, and checks scheduling patterns (such as “once per month” or “each term”). The server applies update rules that adjust event dates, update references to months or seasons, and align the event with the current bulletin's time range.
Output: The server writes updated structured information for recurring events into the database, producing refreshed records that will be used in subsequent text generation.

### Step 6:

The server composes a global prompt sentence for the generative AI model to generate a draft body of the class bulletin.
Input: The server aggregates structured event information, notice information, and updated recurring information from the database for the target newsletter.
Processing: The server formats this information into a human-readable, ordered list embedded in a natural-language instruction. The server concatenates a fixed instruction header (for example, “Using the following structured data about class events and notices, write a complete class newsletter for parents.”) with a list of events and notices.
Output: The server produces a complete prompt sentence containing the structured data and stores it temporarily in memory or in a PROMPTS table for logging.

### Step 7:

The server sends the global prompt sentence to a generative AI model and receives candidate text for the bulletin body.
Input: The server passes the prompt sentence to an external or internal generative AI model via an application programming interface, together with configuration parameters (maximum tokens, temperature, stop conditions).
Processing: The generative AI model tokenizes the prompt, computes attention weights across tokens using a transformer architecture, and iteratively generates output tokens that form paragraphs, headings, and bullet lists. The server receives streaming or batched token outputs, decodes them into character text, and assembles the full draft body of the bulletin.
Output: The server stores the candidate text of the bulletin body in the NEWSLETTERS table as a draft field and associates it with the corresponding structured information.

### Step 8:

The server segments the candidate text of the bulletin body into information units and associates them with structured records.
Input: The server retrieves the candidate text and the structured information for the corresponding newsletter.
Processing: The server detects section headings, paragraph boundaries, and list markers by scanning for line breaks, punctuation patterns, and keyword indicators. The server splits the text into discrete information units (such as one section per event or per notice) and links each unit to the corresponding event or notice record via identifiers.
Output: The server produces a set of information unit records (for example, in a SECTIONS table) where each record contains a text snippet, a reference to structured information, and initial assignment of a unit type (main event, schedule, reminder, etc.).

### Step 9:

The server assigns final priorities to information units for layout control.
Input: The server loads importance and relevance scores, information unit types, and any historical engagement data for similar units.
Processing: The server computes a combined priority score for each information unit using a weighted formula that may sum or otherwise aggregate the existing scores. The server may normalize the scores across all units to obtain a ranking.
Output: The server updates the information unit records with final priority values that will determine their placement and emphasis in the layout.

### Step 10:

The server generates prompt sentences for localized rewriting of specific sections if refinement is required.
Input: The server identifies information units that require adjustment (for example, those with missing details or low confidence scores).
Processing: For each target information unit, the server composes a prompt sentence that includes instructions and the structured data for that unit, such as: “Revise only the section about the October 10 museum field trip. Emphasize departure at 9:00, return at 15:00, required items (lunch, water bottle, light jacket), and a short safety note. Keep the tone consistent with the rest of the newsletter.”

The server sends these prompt sentences to the generative AI model with appropriate parameters to limit output length.
Output: The server obtains refined text for the selected sections, updates the corresponding information unit records, and preserves the unchanged sections.

### Step 11:

The server detects content segments that require visual elements and generates prompt sentences for an image generative AI model.
Input: The server reads information units and their types (such as belongings lists, seasonal events, safety notices) from the database.
Processing: The server applies rules that map unit types to image types (for example, checklists, scene illustrations, safety symbols). For each targeted unit, the server constructs a descriptive prompt sentence, such as:

“Create a simple, colorful illustration for an elementary school newsletter showing children happily preparing for an autumn field trip, with backpacks, lunch boxes, and water bottles.”
Output: The server outputs a set of image-generation prompt sentences associated with specific information units.

### Step 12:

The server sends the image-generation prompt sentences to an image generative AI model and stores the resulting visual elements.
Input: The server provides the text prompts and desired image resolution and aspect ratio to the image generative AI model.
Processing: The image generative AI model maps the prompt text into an embedding space and generates image information by iteratively updating pixel or latent representations according to a trained generative algorithm (for example, diffusion or adversarial training). The server receives generated images as files or binary streams, verifies their format and size, and assigns identifiers.
Output: The server stores the generated images in a file system or object storage and records references to them in the ILLUSTRATIONS table with links to the corresponding information units.

### Step 13:

The server performs image recognition on uploaded photographs to select candidate photographs for insertion.
Input: The server loads raw photograph data associated with the newsletter from the PHOTOS table or storage paths.
Processing: The server applies a convolutional neural network-based image recognition module to each photograph to detect faces, count persons, and evaluate composition and quality. The server calculates scores based on detected features, such as focusing penalty for blurred faces or low brightness.
Output: The server records a numeric score and selection flag for each photograph and marks the highest-scoring photographs as candidate photographs for layout insertion.

### Step 14:

The server generates layout data using information unit priorities, visual elements, and candidate photographs.
Input: The server retrieves information units with priority scores, associated structured information, generated visual elements, and selected candidate photographs.
Processing: The server defines a page grid model with columns, rows, and margins. The server assigns high-priority units to larger or more prominent regions and associates relevant visual elements and photographs with each unit. The server calculates coordinates, area sizes, and font sizes for titles and body text according to the importance level.
Output: The server creates layout data structures that describe page positions, regions, text frames, and image frames, and stores them in layout records linked to the newsletter.

### Step 15:

The server renders the final class bulletin into a distribution-ready data format.
Input: The server passes the layout data, text content for each information unit, and references to images and photographs to a layout engine or document renderer.
Processing: The layout engine merges text into text frames, scales and places images according to coordinates, paginates the document, and generates a final file in a print-oriented format and/or an electronic display format. The server monitors the rendering process and handles any errors or resource constraints.
Output: The server outputs final output data, such as a PDF or an HTML file, stores it in the storage device, and records a retrieval URL or identifier in the NEWSLETTERS table.

### Step 16:

The terminal receives the final output data or a reference to it and provides a preview to the user.
Input: The terminal obtains a URL or binary document data from the server response.
Processing: The terminal downloads the document if necessary, opens the file using a built-in viewer or browser rendering engine, and displays pages, text, and images on the screen. The terminal may also retrieve additional metadata, such as section lists or warnings, from the server.
Output: The terminal presents the generated class bulletin to the user and provides interface controls to scroll, zoom, print, or return feedback.

### Step 17:

The user reviews the generated bulletin and optionally requests modifications.
Input: The user views the previewed bulletin and identifies parts that need correction or adjustment.
Processing: The user interacts with the terminal to edit specific fields (such as changing a date or correcting a title), disable or replace a photograph, or request emphasis on a certain notice. The terminal captures these actions as structured edit instructions.
Output: The terminal sends an update request containing the identifiers of affected information units, edited text values, and image selection changes back to the server.

### Step 18:

The server applies user edits and performs localized regeneration and re-layout as needed.
Input: The server receives the structured update request from the terminal.
Processing: The server updates relevant database records for events, notices, sections, and photos. For sections heavily modified or flagged for rephrasing, the server constructs new, focused prompt sentences for the generative AI model, regenerates only those sections, and recalculates priorities if necessary. The server then partially updates the layout data, adjusting text frames and image positions only where content lengths or emphasis levels changed.
Output: The server produces an updated set of layout data and an updated final document, stores the new version, and provides an updated URL or document to the terminal for re-preview.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional document-generation systems that utilize machine learning models or rule-based templates typically focus on transforming user-provided text into formatted output, but they exhibit several technical deficiencies from the standpoint of computer technology.

First, conventional systems generally treat all input text uniformly, without quantitatively modeling the importance and contextual relevance of individual information elements. As a result, the internal representation used by the system for layout and generation is coarse and flat, which leads to suboptimal allocation of computational resources: important information may receive the same processing priority as marginal information, and visual emphasis in the rendered output must be added manually by the user. This increases the number of user interactions, causes repeated client-server round trips, and leads to inefficient use of processing and communication resources.

Second, typical generative AI integrations simply forward raw user text to a generative model, receive a body of text, and then apply fixed layout templates. Such approaches do not exploit the generative model as a programmable component via structured prompt sentences derived from internal analysis. Consequently, the system cannot dynamically adapt generation behavior based on quantitative importance scores, document structure, or display constraints, which results in additional post-processing, redundant regeneration requests, and inconsistent output quality across devices and formats.

Third, existing systems rarely integrate multimodal emotion estimation into the core document-generation pipeline. User state (for example, stress, anxiety, or satisfaction) and recipient preferences are usually not modeled as parameters inside the content-generation logic. Instead, any tone or style adjustment is performed manually or by simplistic global settings. This leads to a technical problem in that the same static generation and layout process is executed regardless of user state, causing unnecessary iterations, wasted computational cycles, and low efficacy in communication, particularly in bandwidth-constrained or real-time environments.

Fourth, image handling in known systems is often decoupled from text importance and emotion estimation. Images are manually chosen or trivially matched by keywords, without objective evaluation of content and quality. This lack of integrated image analysis and selection means that the system fails to optimize image selection and placement in a computationally informed way. As a result, the rendering engine must perform additional corrective layout operations, which increases CPU and memory utilization on the server and client, and also increases perceived latency for the user.

Fifth, many interfaces for document-generation platforms require complex operations or technical knowledge, such as detailed template configuration or direct manipulation of layout parameters. Users unfamiliar with operation of information processing apparatuses must repeatedly adjust and re-upload content, which increases network traffic and server load. Moreover, because the system does not structurally capture edits as constrained update instructions, partial updates cannot be efficiently propagated to the generative AI model, so entire documents are regenerated even when only small sections are changed.

Accordingly, there is a need for a technical architecture in which a processor: (i) structurally analyzes user input into an internal, importance-weighted representation; (ii) generates specialized prompt sentences driving a generative AI model at multiple stages (body generation, tone adaptation, layout guidance, and partial updates); (iii) integrates multimodal emotion estimation and image analysis into the core pipeline; and (iv) coordinates these components to reduce redundant processing, improve layout consistency, and decrease the number of client-server interactions needed to obtain a final, device-appropriate document. Such an architecture would improve the functioning of the computer system itself by more efficiently orchestrating natural language processing, generative AI inference, layout rendering, and file-format conversion while reducing manual interventions and reprocessing cycles.

The specific processing by the specific processing unit 290 of the data processing device 12 in Application Example 2 is realized by the following means.

The present invention provides a server comprising a processor configured to parse natural language data input by a user, quantify importance and relevance of information contained in the natural language data, classify the information based on the quantified importance and relevance, and structure the classified information into a format suitable for an information-delivery document; to generate, from the structured information, a first prompt sentence that explicitly specifies document type, required factual elements, and tone parameters, and to input the first prompt sentence to a generative AI model so as to cause the generative AI model to generate a body text of the information-delivery document; to generate, based on the generated body text and the classified information, a second prompt sentence including layout conditions that distinguish visually important information from auxiliary information and that specify emphasis levels, and to generate visual layout data in which character information and image information are combined in accordance with the layout conditions; to perform image analysis processing on image data input by the user and on image data stored in an external storage device, to evaluate content and quality of each piece of image data, and to generate a third prompt sentence for selecting at least one image suitable for content and visual balance of the information-delivery document, the processor being further configured to insert a selected image into the visual layout data based on the third prompt sentence; to execute emotion estimation processing based on an input history of the user, a viewing history of the user, and real-time biometric information of the user to estimate an emotional state of the user, to generate a fourth prompt sentence that instructs the generative AI model to change a writing style, a tone, and an amount of information of the information-delivery document in accordance with the emotional state while preserving factual content, and to input the fourth prompt sentence together with at least part of the body text to the generative AI model so as to cause the generative AI model to regenerate or modify the body text; to generate layout adjustment conditions for changing display styles including color scheme, font size, image placement, and text placement in accordance with the estimated emotional state, and to update the visual layout data as emotion-adapted layout data; to generate a fifth prompt sentence for converting the emotion-adapted layout data into a print-oriented electronic file format or a display-device-oriented electronic file format, to generate final output data based on the fifth prompt sentence, to store the final output data in a storage device, and to transmit the final output data to a terminal device via a communication device; and to generate, in response to an editing instruction from the user, a sixth prompt sentence for re-inputting at least part of the final output data to the generative AI model as constrained update instructions, and to update the body text and the layout of the information-delivery document within a limited range based on an output of the generative AI model. This enables a computer system to internally manage importance-weighted content structures, emotion-aware generation parameters, and image-selection criteria as explicit prompt sentences that control a generative AI model at multiple stages, thereby reducing redundant regeneration, improving consistency between textual content and visual layout, decreasing user interaction steps and client-server round trips, and enhancing overall processing efficiency and responsiveness of document generation across different output formats and display devices.

The term “natural language data” refers to character string data or speech-derived text data expressed in a human language, including sentences, phrases, and words input by a user for use in generating an information-delivery document.

The term “importance” refers to a quantitative measure indicating how essential a particular piece of information is relative to other pieces of information within the same natural language data, as determined by statistical analysis, rule-based analysis, or model-based scoring.

The term “relevance” refers to a quantitative measure indicating how closely a particular piece of information is related to a target topic, document type, or communicative purpose within the information-delivery document.

The term “classify the information” refers to assigning individual information elements to categories or labels, such as topic, section, priority level, or semantic type, based on importance and relevance scores or other analysis results.

The term “information-delivery document” refers to a document or digital content item whose primary purpose is to convey information from a sender to one or more recipients, including newsletters, notices, announcements, promotional materials, and similar communications.

The term “structure the classified information” refers to arranging and organizing the classified information elements into a predefined or learned data schema that specifies sections, fields, and relationships suitable for subsequent document generation.

The term “prompt sentence” refers to a machine-readable instruction sequence expressed in natural language or mixed symbolic form, which is provided as input to a generative AI model in order to control the generation, modification, or formatting of text or other content. The term “generative AI model” refers to an artificial intelligence model that, in response to an input prompt sentence, automatically outputs generated content such as text, images, or layout descriptions, and includes language models, multimodal models, and other generative models.

The term “body text” refers to the main textual content of the information-delivery document, excluding metadata, control information, and low-level formatting codes, and including narrative sections, lists, and explanatory paragraphs.

The term “layout conditions” refers to parameters and rules specifying how textual and graphical information should be arranged on a display or page, including positions, sizes, spacing, emphasis levels, and hierarchical relationships among elements.

The term “visual layout data” refers to structured data describing a concrete arrangement of elements on a page or screen, including character information, image information, and style attributes such as fonts, colors, and margins.

The term “character information” refers to information expressed as textual characters, including letters, numerals, punctuation marks, and symbols, which are rendered in a particular font and style in the visual layout.

The term “image information” refers to information expressed as raster or vector graphics, such as photographs, illustrations, icons, or diagrams, which are placed within the visual layout in association with textual content.

The term “image analysis processing” refers to computational processing applied to image data in order to extract features such as objects, scenes, faces, brightness, sharpness, and other quality indicators used for evaluation or selection.

The term “external storage device” refers to any storage component or subsystem, local or remote, that is accessible by the server and stores image data or other files separately from main memory, including databases, file servers, and cloud storage.

The term “content and quality of image data” refers to semantic aspects of an image, such as subjects and scenes, and technical aspects of an image, such as resolution, brightness, contrast, noise, and sharpness.

The term “visual balance” refers to an attribute of the visual layout indicating that textual and image elements are arranged in a way that is aesthetically pleasing and easily readable, without excessive crowding or disproportionate emphasis.

The term “input history” refers to records of past inputs provided by a user to the system, including previously entered text, uploaded images, and selected options.

The term “viewing history” refers to records of past presentations of documents or content to a user or recipient, including which documents were viewed, when they were viewed, and for how long they were viewed.

The term “real-time biometric information” refers to physiological or behavioral data acquired during system use, such as facial expressions, gaze direction, voice characteristics, or other measurable signals used to estimate an emotional state.

The term “emotion estimation processing” refers to computational procedures that analyze text, biometric information, and behavioral data to infer an emotional state such as joy, anxiety, neutrality, or other affective categories, optionally with confidence scores.

The term “emotional state” refers to an internal affective condition of a user inferred by the system, such as positive, negative, or neutral mood, or more specific states such as joy, satisfaction, concern, or stress.

The term “writing style” refers to characteristics of the generated text including formality, sentence length, vocabulary selection, and structural patterns used to express the content.

The term “tone” refers to an expressive quality of the generated text, such as cheerful, calm, reassuring, urgent, or neutral, which conveys an attitude or emotional nuance beyond factual content.

The term “amount of information” refers to the total quantity of content provided in the information-delivery document, including number of sentences, level of detail, and presence or absence of optional sections.

The term “display styles” refers to visual presentation attributes applied to the visual layout, including but not limited to color scheme, font size, font weight, line spacing, and positional relationships of text and images.

The term “color scheme” refers to a set of colors and their combinations used to render text, backgrounds, and graphical elements in the visual layout.

The term “font size” refers to a numeric or categorical value specifying the relative size at which characters are rendered in the layout.

The term “image placement” refers to positions and sizes assigned to images within the visual layout, including alignment relative to text blocks and page boundaries.

The term “text placement” refers to positions, alignment, and grouping of text blocks, paragraphs, headings, and lists within the visual layout.

The term “emotion-adapted layout data” refers to visual layout data that has been modified according to the estimated emotional state, such that display styles and emphasis are adjusted to match the emotional context.

The term “print-oriented electronic file format” refers to an electronic document format optimized for high-fidelity printing on paper, such as a page-description format with fixed layout.

The term “display-device-oriented electronic file format” refers to an electronic document or data format optimized for presentation on electronic display devices, including formats for web browsers, digital signage, and wearable displays.

The term “final output data” refers to data representing a completed version of the information-delivery document in a target electronic file format, ready for printing, display, or distribution to recipients.

The term “storage device” refers to a hardware or logical component capable of storing data persistently or semi-persistently, including magnetic, optical, or semiconductor-based storage, and associated management software.

The term “communication device” refers to a hardware or logical component used to transmit and receive data between the server and one or more terminal devices over a communication network.

The term “terminal device” refers to a user-facing computing device, such as a personal computer, tablet, smartphone, or dedicated display unit, through which a user inputs data and views generated documents.

The term “editing instruction” refers to input data indicating a user's request to modify, correct, or update part of the body text, layout, or other aspects of the information-delivery document.

The term “constrained update instructions” refers to instructions that limit the scope of modifications requested from the generative AI model to specific sections, paragraphs, or properties of the document, while preserving other portions unchanged.

The term “graphical user interface” refers to an interface presented on a display that allows a user to interact with the system using visual elements such as icons, buttons, text fields, and menus, possibly combined with voice or handwriting input.

The term “structured data” refers to data organized according to a predefined schema with labeled fields and types, enabling systematic processing by the server, such as a data object including event dates, titles, and messages.

The term “recipient” refers to an end user who receives and views the generated information-delivery document, and whose behaviors and responses may be analyzed for optimization.

The term “selection history” refers to records of which items, links, or options were chosen by a recipient or user when interacting with presented content.

The term “response history” refers to records of reactions or feedback given by a recipient, such as survey answers, clicks on specific content elements, or explicit ratings.

The term “information item” refers to a discrete unit of content in the information-delivery document, such as a specific fact, message, section, or bullet point.

The term “information items to be emphasized” refers to information items that the system has determined should be visually or textually highlighted to attract recipient attention based on analysis results.

The term “information items to be omitted” refers to information items that the system has determined may be suppressed, shortened, or removed from the presented document without significantly degrading communication effectiveness.

In one embodiment, a system for generating information-delivery documents is implemented as a combination of a server and one or more terminal devices connected through a communication network. The server includes at least one processor, a main memory, a non-volatile storage device, and a communication interface. The terminal includes a processor, a display device, an input device such as a keyboard, a touch panel, a microphone, and optionally a camera.

The server executes a server-side software stack implemented, for example, in a general-purpose programming language such as Python running on an operating system such as a server-class operating system. The server uses a web application framework, for example a framework of the type that provides HTTP routing and JSON parsing (such as frameworks of the Flask type), to receive and respond to requests from the terminal. The server further uses a natural language processing library of the spaCy type or NLTK type, a statistical learning library of the scikit-learn type, and an image processing library of the OpenCV type. The server optionally accesses a vision analysis service of the image-recognition-API type, a PDF rendering engine of the WeasyPrint type, and a relational database of the SQLite type or another database type. The server communicates with an external generative AI model, which may be a large language model provided as an inference service, and may also communicate with an image generative model such as a diffusion-based image synthesis model. The server also uses an emotion estimation module that can incorporate text sentiment analysis (for example, using a sentiment-analysis library similar to TextBlob) and facial-expression recognition (for example, using a framework of the Mediapipe type).

The terminal executes a terminal-side software stack implemented, for example, as a browser-based application using HTML, JavaScript, and a component-based user interface library of the React type, or as a native application with equivalent capabilities. The terminal displays a graphical user interface that includes text input fields, file selection controls, voice input buttons, and simple icons and buttons designed for users unfamiliar with detailed operation of information processing apparatuses. The terminal optionally uses a speech recognition service such as a speech-to-text API to convert captured audio into text, and sends the resulting text to the server.

The user uses the terminal to input natural language data describing content of an information-delivery document, such as announcements, schedules, promotional information, or educational communications. The user may also upload image data, such as photos or illustrations, and may provide optional feedback or rating inputs to indicate preferred style. The terminal converts the user inputs into structured data objects, such as collections of key-value pairs including text fields, timestamps, and device identifiers, and transmits these to the server over a secure communication channel.

The server receives the structured data from the terminal and stores the data in a storage device, associating each data set with a document identifier. The server then performs natural language parsing. In one configuration, the server loads a spaCy-type model that implements a tokenization module, a part-of-speech tagging module, and a named entity recognition module. The server applies these modules to the input natural language data to segment the text into tokens, assign part-of-speech tags, and detect named entities such as dates, locations, event names, and numerical values. The server then applies a term-weighting algorithm of the TF-IDF type implemented using a scikit-learn-type library to compute an importance score for each token or phrase. The server constructs an internal data structure in memory that represents each detected information element with attributes such as text string, semantic type, part-of-speech, and importance score.

This structured representation enables the server to treat important elements differently from less important elements in subsequent processing. Because the server uses numeric importance scores, the server can sort, filter, and prioritize information elements using simple vector operations and matrix multiplications that are efficiently executed by the processor. Consequently, the server reduces the amount of data that needs to be passed to the generative AI model and to the layout engine, which reduces communication load and processing time compared to systems that blindly pass the full raw text to external services.

The server next constructs a logical schema for the information-delivery document. For example, the server may define sections such as “Title”, “Greeting”, “Main Event Information”, “Instructions”, and “Closing”. The server maps classified information into these sections according to rules implemented in a rule engine. The rule engine may use a dictionary of keywords, entity types, and syntactic patterns to decide which phrases belong to which section. For example, the server may place all date entities and event-related phrases with high importance scores into the “Main Event Information” section. The server stores the resulting schema as a structured object in memory.

The server uses the schema, together with parameters representing an estimated emotional state, to generate a prompt sentence for the generative AI model. The server implements a prompt-construction module that loads a textual template and replaces placeholder tokens with concrete values such as dates, event names, and tone descriptors. The prompt-construction module generates natural language instructions that explicitly specify required elements and constraints. One example of such a prompt sentence is:

“You are an AI that creates class newsletters. Based on the following information, write a bright and positive newsletter in Japanese for parents.
Date: 2026 May 15 (Friday)
Event: School excursion
Items to bring: lunch box and water bottle
Teacher's impression: The children were very energetic today.

Use a cheerful and encouraging tone, highlight the date and items to bring, and keep the total length under 500 Japanese characters.”

The server then sends this prompt sentence to the generative AI model over a network. The generative AI model can be realized as a transformer-based neural network, for example a multi-layer encoder-decoder or decoder-only architecture with self-attention, cross-attention, and feedforward sublayers. The model is trained beforehand on large-scale text corpora using an autoregressive language modeling objective or a masked-token prediction objective. During training, the model updates internal weight parameters using gradient-based optimization such as stochastic gradient descent with adaptive variants, minimizing a loss function such as cross-entropy between predicted tokens and ground truth tokens. The model may optionally be fine-tuned using reinforcement learning from human or synthetic feedback to respond appropriately to prompt instructions.

During inference, the generative AI model receives the prompt sentence tokenized into subword units, generates contextual vector representations through multiple layers of attention and nonlinear transformation, and outputs tokens representing the body text of the information-delivery document. The server receives the generated tokens, decodes them into a character sequence, and stores the resulting body text in the storage device linked to the document identifier.

Because the server encodes importance, section structure, and tone as explicit constraints in the prompt sentence, the generative AI model can generate text that already respects these constraints. As a result, the server avoids repeated generate-and-filter cycles, thereby improving computational efficiency and reducing latency. This differs technically from simply automating human drafting because the server uses internal quantitative analysis and structured prompts as control signals within the generative pipeline.

The server further integrates emotion estimation into the generation process. The server maintains a module that analyzes the user's input history, viewing history, and optionally real-time biometric information captured via the terminal (for example, facial images or voice signals). For text-based sentiment, the server can use a classifier implemented as a smaller neural network that takes as input sentence embeddings and outputs a polarity score and confidence. For facial expressions, the server uses a landmark-detection model of the Mediapipe type to obtain geometric features of facial landmarks and then classifies these features into emotion categories using a trained classifier network. The server fuses emotion signals from multiple modalities using a weighted averaging or rule-based scheme and stores the resulting emotional state and confidence score.

The server uses this emotional state information to generate additional prompt sentences that instruct the generative AI model how to adjust writing style and tone. For instance, the server may generate a refinement prompt such as:

“The current text is slightly too neutral. Adjust the following newsletter text so that it feels reassuring and supportive for parents who may feel anxious about tomorrow's weather. Do not change the factual information. Keep the language in Japanese.”

The server attaches the existing body text to this refinement prompt and sends the combined input to the generative AI model. The generative AI model, using the same transformer architecture, processes both the instruction and the original text and outputs a modified version of the body text. This two-stage process, in which the server first generates content and then refines tone based on emotion, allows finer control of the generative AI model and reduces risk of factual changes, thereby improving reliability and reducing the number of cycles needed to achieve acceptable quality.

The server also performs image analysis and selection using computer vision algorithms. When the user uploads image data or when the server retrieves images from an external storage device, the server executes OpenCV-type routines to compute brightness histograms, edge density, and blur metrics. The server may also send the image to an image-recognition-API-type service to detect labels such as “children”, “school”, or “product”. The server evaluates the content and quality of each image using thresholds on brightness, blur, and semantic labels. The server then generates a prompt sentence or a selection rule determining which image should be inserted into which part of the layout. Because the server uses quantifiable quality metrics, the server can automatically avoid low-quality or irrelevant images, reducing manual trial-and-error and lowering the number of layout reflows.

The server then constructs visual layout data. In one embodiment, the server uses a layout engine implemented with a combination of a component-based UI framework such as React and a utility-first style framework such as TailwindCSS. The server converts the structured sections and importance scores into a tree of layout components. For example, the server maps the “Main Event Information” section to a header component with a larger font size, and secondary details to smaller text components. The server chooses color schemes and font sizes based on the emotion-adapted parameters. For example, a bright palette and large, bold fonts may be selected if the emotional state is joyful, whereas a more subdued palette and slightly smaller fonts may be chosen for anxious states.

The server represents the layout as a data structure containing component types, coordinates, style classes, and image references. The server may optionally run a headless browser engine to render the layout into a final HTML and CSS document and to detect overflow or layout collisions by reading computed bounding boxes. If the server detects that an important text block is truncated or overlapping, the server automatically adjusts layout parameters such as font size, line spacing, or margins and re-renders the layout. This feedback loop is performed programmatically within the server and does not require user intervention. Because this optimization is performed using structured layout data, the server can converge to a visually balanced layout with fewer iterations than would be required with manual adjustment, and can reuse optimized patterns across similar documents.

The server finally converts the emotion-adapted layout data into target output formats. For print-oriented formats, the server sends the HTML and CSS to a PDF generation library such as WeasyPrint, which interprets the document and renders it into a paginated PDF with embedded fonts and images. For display-device-oriented formats, the server may output responsive HTML for browsers, or raster images at resolutions suited to digital signage. The server stores the final output data in a storage device, associates URLs or identifiers with the data, and transmits references or content itself to the terminal via the communication interface.

The terminal receives the final output data and presents a preview to the user. The user can review the generated document and, if necessary, request limited edits. For example, the user may change a date, modify one sentence, or replace an image. The terminal sends an editing instruction indicating the targeted section and the new content. The server interprets the editing instruction as constrained update instructions and generates a new prompt sentence that asks the generative AI model to update only the specified part of the body text. Because the server specifies which sections must remain unchanged, the generative AI model can modify the document with minimal recomputation, and the layout engine only needs to re-render affected components. This approach significantly reduces processing compared to regenerating the entire document, thereby improving computational efficiency and reducing network traffic.

The server can also analyze behavior of recipients of the information-delivery document. When the document is distributed as an electronic file or via a web interface, the server logs viewing history, selection history, and response history. The server processes these logs to derive statistics about which sections are frequently viewed or clicked. The server uses a learning module, which may be implemented as a simple logistic regression or a small neural network, to correlate information-item attributes (such as topic, position, and length) with engagement outcomes. The server then generates prompt sentences for future documents that instruct the generative AI model to emphasize items that historically have led to higher engagement and to shorten or omit items associated with low engagement. This feedback mechanism improves the effectiveness of documents while reducing unnecessary content, which in turn reduces data volume transmitted to terminals and improves rendering performance on low-power devices.

In this way, the system improves computer technology itself rather than merely automating a human drafting task. The server uses specific data structures (importance-weighted representations, section schemas, emotion parameters) and specific algorithms (TF-IDF computation, transformer-based generation with constrained prompts, layout optimization with feedback from rendering results, and selective regeneration) to orchestrate multiple modules in a non-conventional manner. This orchestration reduces unnecessary recomputation by the generative AI model, reduces layout correction iterations, and decreases communication traffic between the server and terminal. Moreover, by integrating emotion estimation and quantitative importance analysis into the control of the generative AI model through explicitly constructed prompt sentences, the server achieves a level of adaptive generation and layout tuning that cannot be replicated by simple template automation. Alternative embodiments are possible. For example, the server may employ a different natural language processing library, such as a library of the transformer-embedding type, instead of spaCy or NLTK. The generative AI model may be hosted locally on the server, for example as a transformer network implemented in a deep learning framework of the TensorFlow or PyTorch type, rather than accessed as a remote service. In such a case, the server allocates model weights in GPU memory and performs inference using optimized matrix multiplication kernels. The emotion estimation module may use different features, such as heart rate or skin conductance from wearable sensors, as additional biometric inputs. The layout engine may employ a different rendering technology, such as a vector-graphics based engine, instead of an HTML and CSS based engine. The core concept of the embodiments remains the same: the server builds and uses structured representations of content, emotion, and visual requirements to generate tailored prompt sentences that control a generative AI model and related modules at multiple stages, thereby improving processing efficiency, consistency, and responsiveness of document generation and distribution.

In another embodiment, the terminal is implemented as a dedicated kiosk or digital signage controller. The terminal in this case directly displays the generated document on a large display device, and the user may be a store operator or teacher who provides only a short textual prompt. The server still performs the same internal processing, but focuses on generating display-device-oriented formats with larger fonts and reduced text. The use of importance scores and emotion parameters allows the server to choose which text segments to omit in space-constrained layouts. As a result, the system can automatically produce legible, emotionally appropriate signage in near real time with reduced computational overhead and minimal user attention.

In still another embodiment, the system can be extended to handle multi-lingual documents. The server maintains language-specific sections in the schema and can generate separate prompt sentences specifying target languages. The generative AI model generates body text in multiple languages, and the layout engine arranges them in parallel columns or separate pages. Emotion and importance handling remain language-independent at the representation level, which allows the server to apply the same optimization strategies for different localizations without significant redesign.

Through these embodiments, the server, the terminal, and the user cooperate to realize an information-delivery document generation system that leverages generative AI models and structured prompt sentences in a manner that measurably improves computational efficiency, accuracy of content placement, and adaptability to user emotion and recipient behavior, while reducing manual workload and network traffic.

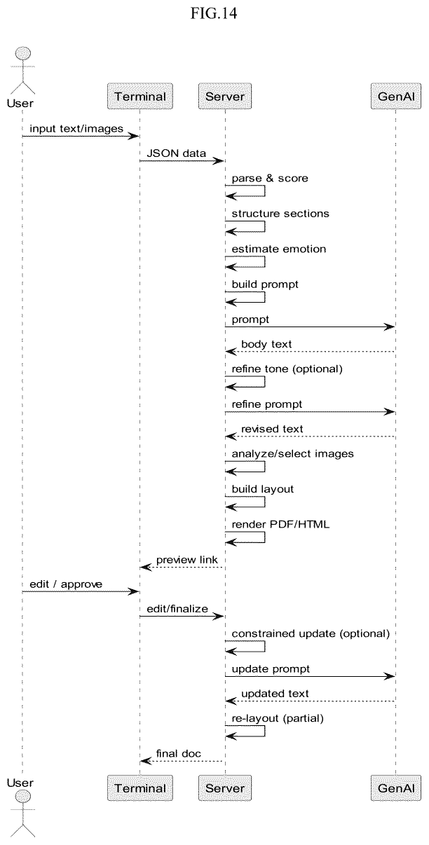

The following describes the processing flow using FIG. 14.

### Step 1:

User operates the terminal to input source information.

User types natural language text describing events, announcements, or promotional content into text fields displayed on the terminal, and optionally uploads images via a file-selection control or speaks into a microphone to provide voice input.

Terminal receives keyboard text, captured audio, and selected image files as input.

Terminal converts the audio stream into a digital signal, sends the signal to a speech-to-text service, receives transcribed text, and concatenates the transcribed text with typed text to form a unified text string.

Terminal constructs a structured object that includes the unified text string, metadata such as timestamps and user identifiers, and paths or binary data for uploaded images, and sets this structured object as the output of Step 1.

### Step 2:

Terminal formats and transmits the input data to the server.

Terminal takes as input the structured object generated in Step 1 and serializes it into a network-transferable format such as JSON.

Terminal attaches device identifiers and session tokens, performs basic validation (for example, checks that the main text field is not empty), and then sends the JSON payload to the server via HTTPS using a predefined API endpoint.

Terminal sets as output a transmitted request containing the JSON payload, which serves as the input for the server in the next step.

### Step 3:

Server receives and stores the raw input data.

Server receives as input the JSON payload from the terminal through the communication interface and decodes the JSON into an internal data structure in memory.

Server validates required fields (for example, checks for presence of text content and language code), assigns a document identifier, and writes the decoded data into a database table in a storage device together with the document identifier and timestamp.

Server sets as output a stored record containing the document identifier and raw user data, and optionally returns an acknowledgment message to the terminal.

### Step 4:

Server performs natural language parsing and importance scoring.

Server uses as input the text field from the stored record associated with the document identifier.

Server loads a natural language processing model, tokenizes the text into words and sentences, assigns part-of-speech tags, and performs named entity recognition to detect dates, locations, names, and numerical values.

Server then applies a TF-IDF algorithm implemented in a machine learning library to compute an importance score for each token or phrase, normalizes these scores, and associates them with corresponding text spans.

Server constructs an annotated text representation that includes, for each information element, the original substring, semantic type, and importance score, and saves this representation in the database as the output of Step 4.

### Step 5:

Server classifies and structures information into document sections.

Server uses as input the annotated text representation from Step 4.

Server applies a rule engine that examines entity types, surrounding words, and importance scores to classify each information element into logical categories such as title, event description, date, instructions, and optional notes.

Server orders elements within each category by importance, discards redundant or low-importance items when necessary, and populates a section-based schema that defines fields for a target information-delivery document.

Server outputs a structured schema object that maps each section name to a list of prioritized information elements.

### Step 6:

Server estimates user emotion and sets tone parameters.

Server uses as input user text from the raw record, historical interaction logs associated with the user, and, if available, biometric data such as facial images or voice features.

Server applies a text sentiment classifier to compute polarity and subjectivity scores from the text, and applies a facial-expression recognition or voice-analysis model to derive additional emotion indicators.

Server combines these indicators using a weighted aggregation function to infer an emotional state label (for example, joyful, neutral, or anxious) and a confidence value.

Server outputs an emotion profile object that includes the emotional state, the confidence, and derived tone parameters such as desired style (for example, bright or calm) and preferred length.

### Step 7:

Server generates a primary prompt sentence for the generative AI model.

Server uses as input the structured schema from Step 5 and the emotion profile from Step 6.

Server fills a textual template by inserting section data such as event date, event name, and instructions, and by inserting tone parameters such as “bright and positive” or “reassuring and calm” into predefined placeholder positions.

Server creates a prompt sentence that describes the role of the generative AI model, the required structure of the document, mandatory elements to include, and constraints on tone and length.

Server outputs the completed prompt sentence, for example:

“You are an AI that creates class newsletters. Based on the following information, write a bright and positive newsletter in Japanese for parents.
Date: 2026 May 15 (Friday)
Event: School excursion
Items to bring: lunch box and water bottle
Teacher's impression: The children were very energetic today.

Use a cheerful and encouraging tone, highlight the date and items to bring, and keep the total length under 500 Japanese characters.”

### Step 8:

Server calls the generative AI model and generates body text.

Server uses as input the primary prompt sentence from Step 7.

Server sends the prompt sentence to a generative AI model via an inference API, receives a token sequence as output, and decodes the tokens into natural language text representing the body of the information-delivery document.

Server checks the generated text for presence of key elements (such as dates and required items) and for compliance with length constraints, and, if necessary, adjusts the prompt or stops generation early according to predefined control parameters.

Server stores the accepted body text in the database linked to the document identifier and sets this body text as the output of Step 8.

### Step 9:

Server generates an emotion-refinement prompt and adjusts the body text if needed.

Server uses as input the body text from Step 8 and the emotion profile from Step 6.

Server evaluates whether the style and tone of the body text correspond to the emotional state by applying a secondary classifier that scores tone characteristics such as positivity and formality.

Server generates a refinement prompt sentence that instructs the generative AI model to modify the existing text's tone without altering factual information, for example:

“The current text is slightly too neutral. Adjust the following newsletter text so that it feels reassuring and supportive for parents who may feel anxious about tomorrow's weather. Do not change the factual information. Keep the language in Japanese.”

Server concatenates the refinement prompt with the current body text, sends this combined input to the generative AI model, receives modified text, and replaces the original body text if the modified text satisfies tone and content checks.

Server outputs a final, emotion-adapted body text.

### Step 10:

Server performs image analysis and selection.

Server uses as input any image data uploaded by the user and any candidate image data retrieved from an external storage device, as well as the structured schema and the emotion profile.

Server computes image quality metrics such as brightness, contrast, and blur using image-processing functions, and sends images to a recognition engine to obtain semantic labels.

Server applies selection rules that compare image labels with document topics and that reject images with quality metrics below thresholds, and identifies one or more images that best match the main topic and desired emotional tone.

Server outputs a set of selected images together with placement tags indicating where in the document each image should be inserted.

### Step 11:

Server generates layout conditions and visual layout data.

Server uses as input the emotion-adapted body text from Step 9, the structured schema from Step 5, the importance scores from Step 4, and the selected images from Step 10.

Server determines layout conditions such as which information items should be displayed as large headings, which should appear as bullet points, and which should be visually de-emphasized, based on their importance scores and section types.

Server selects a color scheme and font sizes according to the emotional state, associates each section with a layout component type, and assigns positions and sizes for text blocks and images.

Server constructs visual layout data as a structured object that includes component identifiers, text content, style attributes, and image references, and stores this object as the output of Step 11.

### Step 12:

Server converts visual layout data into target output formats.

Server uses as input the visual layout data from Step 11 and a target format specification indicating print-oriented or display-device-oriented output.

Server renders the layout into an intermediate markup format, such as HTML and CSS, and then supplies this markup to a rendering engine that generates a print-oriented file such as a PDF or a set of display-device-oriented files such as image slides or responsive web pages.

Server checks for rendering issues such as text overflow or clipped images and, if necessary, adjusts font sizes or margins and repeats rendering until constraints are satisfied.

Server outputs final output data in the specified electronic file formats and stores file paths or identifiers in the database.

### Step 13:

Server transmits output data and preview information to the terminal.

Server uses as input the identifiers and file paths of the final output data from Step 12 and the document identifier.

Server constructs a response message that includes URLs or binary content for preview and download, attaches metadata such as page count and approximate file size, and sends the response to the terminal via the communication interface.

Server records in a log that the document has reached a preview stage and sets the response as the output of Step 13.

### Step 14:

Terminal displays a preview and accepts editing instructions.

Terminal uses as input the response from the server containing preview resources and metadata.

Terminal loads the preview content into a viewer component, renders the pages or screens on the display, and provides controls for scrolling, zooming, and switching between views.

User reviews the document on the terminal and, if changes are desired, uses editing controls to modify text fields, update specific sections, or select alternative images.

Terminal collects the user's modifications as editing instructions that reference particular sections or elements in the document and outputs these editing instructions to be sent back to the server.

### Step 15:

Server applies constrained updates through new prompt sentences.

Server uses as input the editing instructions from the terminal and the current body text, layout data, and selected images.

Server identifies which sections or elements need to be updated and constructs constrained prompt sentences that instruct the generative AI model to alter only the specified portions of the text or layout, preserving other content unchanged.

Server sends these constrained prompt sentences, along with the current relevant portions of the document, to the generative AI model, receives updated text or layout suggestions, and merges the updates into the existing document representation.

Server updates the visual layout data accordingly and outputs revised output data files, optionally repeating Steps 12 and 13 in a limited scope for the affected sections.

### Step 16:

User finalizes the document and triggers distribution.

User, after confirming that the preview satisfies requirements, interacts with the terminal to issue a finalize command.

Terminal sends a finalize request including the document identifier to the server.

Server marks the document as finalized in the database, locks further automatic changes, and either prepares distribution information for external systems or returns final file links to the terminal.

User obtains the final document from the terminal for printing or electronic distribution, completing the processing chain.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

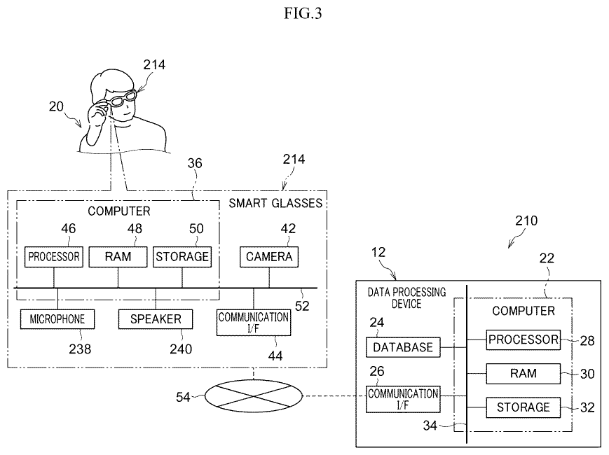

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

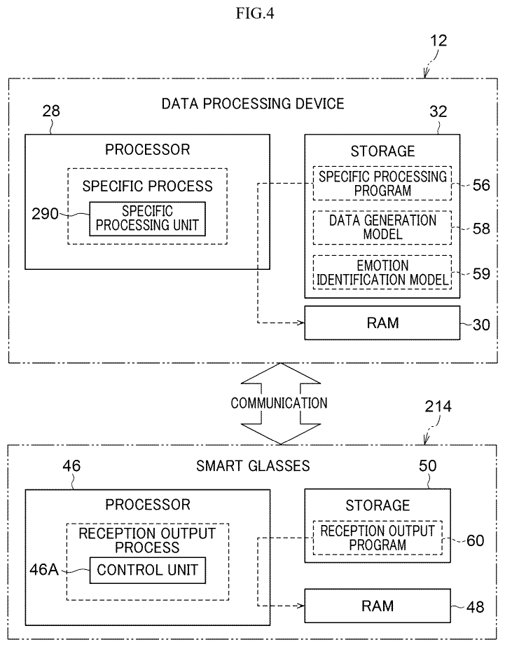

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

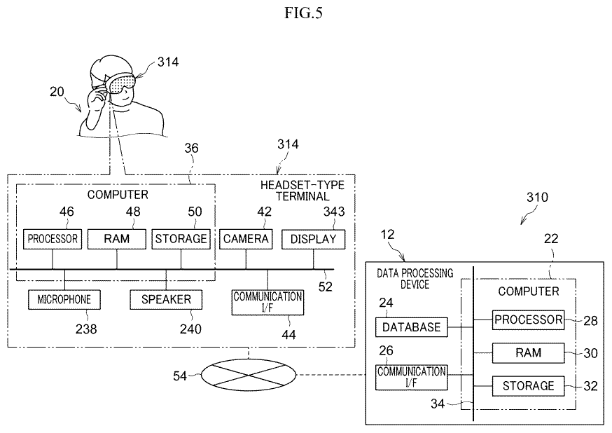

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

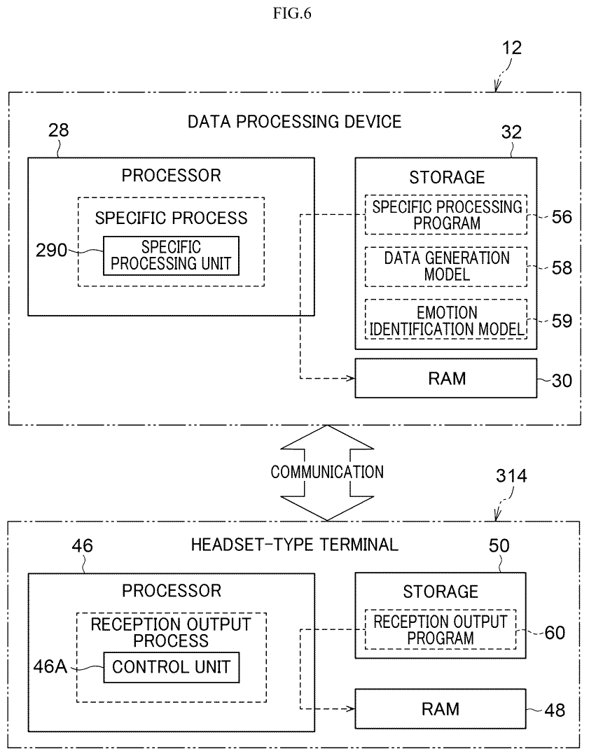

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

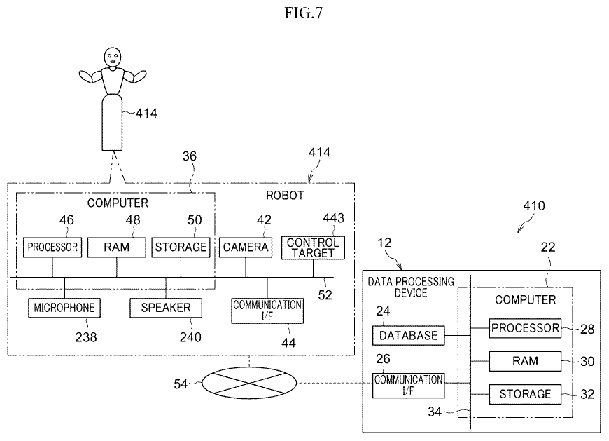

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

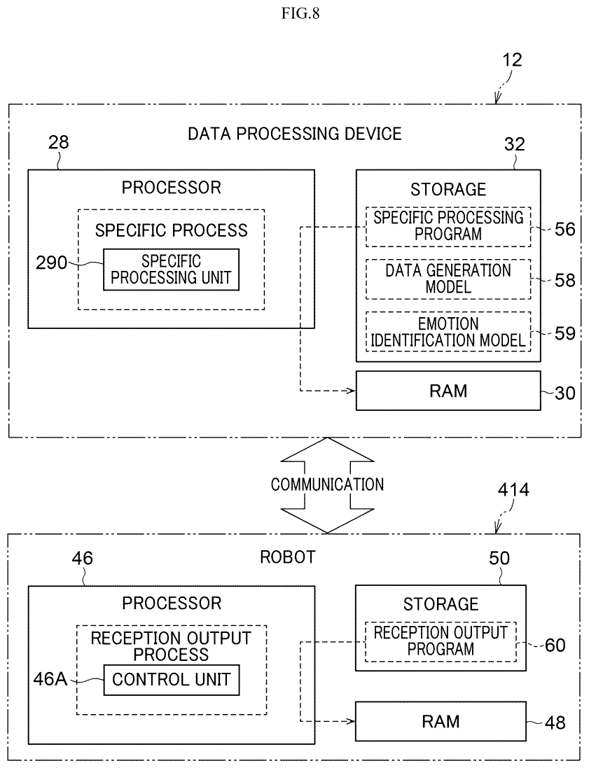

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

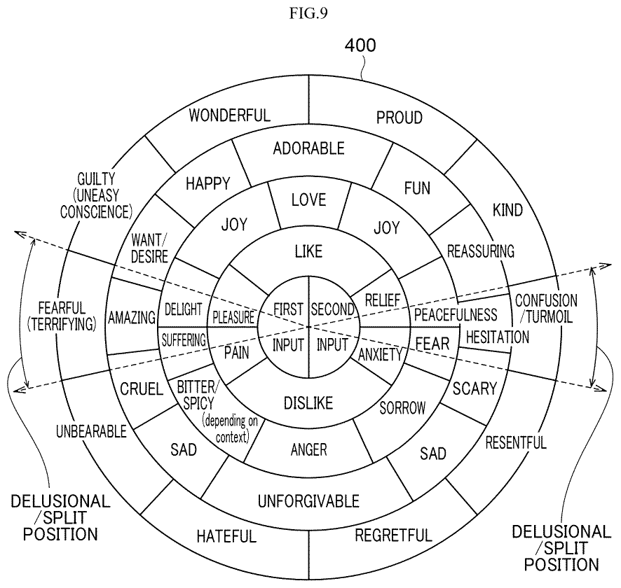

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

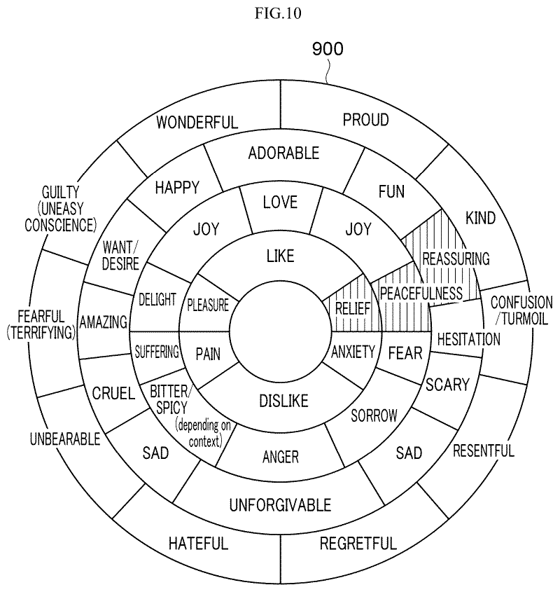

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal operated by a user, text information for a class newsletter, extract event information, belonging information, caution information, and other information units from the text information, and quantify and classify an importance and a relevance of each of the information units,
generate structured data that reconstructs the classified information units into a section structure and a heading structure suitable for a class newsletter format, and construct a prompt sentence based on the structured data to cause a generative AI model to generate a draft body text of the class newsletter,
input the prompt sentence into the generative AI model to obtain the draft body text of the class newsletter, and restructure the obtained draft body text into paragraph information, list information, and heading information,
calculate layout information that determines, for the restructured draft body text, a font size, an emphasis level, and a placement order according to the importance and an information type of each portion of the draft body text, generate a prompt sentence for causing generation of a visually understandable class newsletter layout based on the layout information, and generate layout data in which character information and image information are combined by applying a layout template,
analyze the draft body text and the structured data to extract keywords corresponding to concepts including events, belongings, and cautions, select candidate images based on a correspondence between the keywords and pre-stored image attribute data, generate, when necessary, a prompt sentence for causing an image-generating generative AI model to generate insertion images, and assign the candidate images or generated images to predetermined positions in the layout data in accordance with contents of the class newsletter and visual balance,
receive, from the terminal, additional instructions or correction instructions from the user, generate a revision prompt sentence including the additional instructions or the correction instructions together with the draft body text, input the revision prompt sentence into the generative AI model to obtain a revised draft body text, and repeatedly optimize contents of the class newsletter by re-executing the classification, the calculation of the layout information, and image assignment processing for the revised draft body text, and
generate an output prompt sentence for converting optimized layout data of the class newsletter into a print-use electronic document format or a display-use electronic document format, generate final output data from the layout data based on the output prompt sentence, and output the final output data as a paper medium or an electronic medium.

### (Supplementary 2)

The system according to supplementary 1,
wherein the processor is configured to
generate an interactive screen including visual elements comprising icons, buttons, and guidance messages to simplify operations performed by the user via the terminal, and automatically update contents of the prompt sentence and the layout information according to operation contents of the user on the interactive screen, thereby enabling the user who is unfamiliar with operation of an information processing apparatus to easily create the class newsletter.

### (Supplementary 3)

The system according to supplementary 1,
wherein the processor is configured to
statistically analyze viewing history information, selection history information, and response history information related to previously generated class newsletters in order to reflect reaction tendencies of recipients of the class newsletters, correct the importance of information units that recipients are likely to be interested in based on an analysis result, generate a prompt sentence for instructing the generative AI model to adjust expressions according to degrees of interest of the recipients, and optimize the contents and the layout of the class newsletter based on the corrected importance and the adjusted expressions.

### Application Example 1

### (Supplementary 1)

A system comprising a processor,
wherein the processor is configured to
parse character information input by a user, quantify and classify an importance level and a relevance level of pieces of the character information, and organize the classified information so as to conform to a predetermined information-distribution medium format,
construct a first prompt sentence based on the organized information so as to instruct a generative AI model to generate body data of the information-distribution medium, input the first prompt sentence into the generative AI model, and acquire the body data of the information-distribution medium generated by the generative AI model,
construct a second prompt sentence based on the body data of the information-distribution medium so as to instruct generation of a visually understandable layout, select a template applicable to layout information, and create visual layout data in which text information and image information are combined by applying the template,
perform image recognition processing on image data of image candidates to be inserted into the information-distribution medium, analyze content of the image data based on a result of the image recognition processing, construct a third prompt sentence for instructing selection of an image suitable for content and visual balance of the information-distribution medium, and arrange the selected image in an image region in the visual layout data,
periodically acquire event information or notification information input by the user, generate structured data including the event information or the notification information, automatically convert the structured data into a text-generation prompt sentence and an image-generation prompt sentence, and automatically generate visually attractive content by using the generative AI model,
receive, via a communication network, the structured data transmitted from a terminal, transmit to an interface of the generative AI model the prompt sentence corresponding to the structured data together with generation parameters, and return content data acquired from the generative AI model to the terminal,
specify content elements and visual expressions that are likely to attract interest of a recipient based on an input history and a viewing history of the user and on estimation information regarding an emotional state of the user, construct a fourth prompt sentence for instructing adjustment of expression content in accordance with a result of the specification, and optimize content of the information-distribution medium according to the fourth prompt sentence, and
construct a fifth prompt sentence for instructing output of optimized visual layout data and the content data as print data or electronic display data, and generate final output data based on the optimized visual layout data and the content data.

### (Supplementary 2)

The system according to supplementary 1,
wherein the processor is configured to
provide a user interface that enables intuitive operation by icons and buttons when the user inputs the event information or the notification information via a mobile information terminal or an information processing terminal, and transmit input content acquired through the user interface to the system as the structured data.

### (Supplementary 3)

The system according to supplementary 1,
wherein the processor is configured to
optimize content of the information-distribution medium by using, for a recipient of the information-distribution medium, past viewing history information, selection history information, and evaluation information, specify content elements that are likely to attract interest of the recipient, generate a sixth prompt sentence for instructing content adjustment based on a result of the specification, and dynamically adjust the body data and the visual layout data of the information-distribution medium by using the generative AI model according to the sixth prompt sentence.

### Example 2

### (Supplementary 1)

A system comprising a processor and a storage device,
wherein the processor is configured to
acquire character information and image information input by a user via a terminal, and store the character information and the image information in the storage device,
analyze the character information by natural language processing to extract structured information including date information, event information, notice information, and other attribute information, quantify importance and relevance of each piece of the structured information, classify the structured information based on the quantified importance and relevance, and store a result of the classification in the storage device,
rearrange the structured information stored in the storage device so as to conform to a document format of a class bulletin, generate a prompt sentence including the rearranged structured information as input data, and input the prompt sentence into a generative AI model to cause the generative AI model to generate candidate text of a body of the class bulletin,
acquire past structured information stored in the storage device, identify structured information relating to periodically occurring events, automatically update the structured information relating to the periodically occurring events based on a predetermined update rule, and use updated structured information in generation of the candidate text of the body of the class bulletin,
analyze the candidate text of the body of the class bulletin and the structured information to determine a document structure including headings, body portions, and list portions according to a predetermined template, generate, for each information unit to be included in the class bulletin, a prompt sentence to be input into the generative AI model, and input the prompt sentence into the generative AI model to cause the generative AI model to generate text of the body of the class bulletin,
analyze the text of the body of the class bulletin and the structured information to identify information units to which visual elements are to be added, the information units including at least a belongings list, a seasonal event, and a safety notice, generate, for each of the information units, a prompt sentence for image generation, input the prompt sentence for image generation into an image generative AI model to cause the image generative AI model to generate visual elements, and store the visual elements in association with corresponding information units in the storage device,
analyze a plurality of photograph data uploaded from the terminal by image recognition processing, score the plurality of photograph data based on at least a number of persons, an image quality, a composition, and a presence or absence of bias, select candidate photographs to be inserted into the class bulletin based on a result of the scoring, and store a selection result of the candidate photographs in the storage device,
determine a priority for each information unit based on the text of the body of the class bulletin, the visual elements, the candidate photographs, the structured information corresponding to the text of the body of the class bulletin, the visual elements, and the candidate photographs, and the quantified importance and relevance, generate layout data by automatically optimizing, according to the determined priority, at least a page position, an area size, character decoration, and image placement, and generate a visual layout in which character information and image information are combined based on the layout data, and generate final output data in at least one of a print data format and an electronic display data format based on the layout data and the text of the body of the class bulletin, and transmit the final output data to the terminal.

### (Supplementary 2)

The system according to supplementary 1,
wherein the processor is configured to
control the terminal so that the terminal provides a user interface including a display area, selection elements, and transmission elements for inputting information necessary for the class bulletin, accept input operations via operation elements including guidance images and selection images, and, in response to the input operations, cause the terminal to transmit the character information and the image information from the user to the system.

### (Supplementary 3)

The system according to supplementary 1,
wherein the processor is configured to
acquire, from the storage device, past viewing information, selection information, and
response information relating to recipients of the class bulletin, identify information units that the recipients are likely to find of interest based on the past viewing information, the selection information, and the response information, generate a prompt sentence including a result of the identification, input the prompt sentence into the generative AI model to cause the generative AI model to adjust content and emphasis of the body of the class bulletin, and automatically adjust content of the class bulletin according to an interest level of the recipients.

### Application Example 2

### (Supplementary 1)

A system comprising a processor,
wherein the processor is configured to
parse natural language data input by a user, quantify importance and relevance of information contained in the natural language data, and classify the information based on the quantified importance and relevance; and
structure the classified information into a format suitable for an information-delivery document, generate a prompt sentence for generating a body text of the information-delivery document, and input the prompt sentence to a generative AI model so as to cause the generative AI model to generate the body text of the information-delivery document; and generate, based on the body text of the information-delivery document and the classified information, a prompt sentence including layout conditions that distinguish visually important information from auxiliary information and emphasize the visually important information, and generate visual layout data in which character information and image information are combined based on the prompt sentence; and
perform image analysis processing on image data input by the user and on image data stored in an external storage device, evaluate content and quality of each piece of image data, generate a prompt sentence for selecting an image suitable for content and visual balance of the information-delivery document, and insert a selected image into the visual layout data based on the prompt sentence; and
execute emotion estimation processing based on an input history of the user, a viewing history of the user, and real-time biometric information of the user to estimate an emotional state of the user, generate a prompt sentence for changing a writing style, a tone, and an amount of information of the information-delivery document in accordance with the emotional state, and input the prompt sentence to the generative AI model so as to cause the generative AI model to regenerate or modify the body text of the information-delivery document; and
generate layout adjustment conditions for changing display styles including color scheme, font size, image placement, and text placement in accordance with the emotional state, and update the visual layout data as emotion-adapted layout data based on the layout adjustment conditions; and
generate a prompt sentence for converting the emotion-adapted layout data into a print-oriented electronic file format or a display-device-oriented electronic file format, generate final output data based on the prompt sentence, store the final output data in a storage device, and transmit the final output data to a terminal device via a communication device; and generate a prompt sentence for re-inputting at least part of the final output data to the generative AI model in response to an editing instruction from the user, and update the body text and the layout of the information-delivery document within a limited range based on an output of the generative AI model.

### (Supplementary 2)

The system according to supplementary 1,
wherein the processor is configured to
control a terminal device to provide a graphical user interface that accepts voice input, handwriting input, and selection input so that a user unfamiliar with operation of an information processing apparatus can easily input the natural language data and the image data, convert the voice input into character data, and transmit the character data as structured data to the system.

### (Supplementary 3)

The system according to supplementary 1,
wherein the processor is configured to
analyze, for a recipient of the information-delivery document, a viewing history, a selection history, and a response history of the recipient, generate a prompt sentence for determining information items to be emphasized and information items to be omitted based on an analysis result, and input the prompt sentence to the generative AI model so as to automatically adjust the body text and the layout of the information-delivery document.

What is claimed is:

1. A system comprising:
circuitry configured to:
receive, via a communication interface coupled to a packet-switched network, text data from a terminal device, and apply a computational analysis algorithm to the text data to extract a plurality of information units and assign quantified importance values and relevance values to each information unit;
classify the information units based on the quantified importance values and relevance values to generate structured data, and algorithmically reconstruct the structured data into a section structure and heading structure conforming to a predefined document format;
generate a first prompt sentence encoding the structured data and supply the first prompt sentence to a generative neural network model to obtain draft body text, and generate a second prompt sentence encoding the draft body text and layout constraint parameters to obtain layout data specifying a visual arrangement of textual regions and image regions;
apply a layout template to the layout data to generate a composite document structure, apply an image recognition algorithm to candidate image data to extract image attribute data, generate a third prompt sentence encoding the image attribute data and document context data, supply the third prompt sentence to the generative neural network model to obtain image selection data, and insert selected images into the composite document structure at positions specified by the layout data; and
generate output document data from the composite document structure and transmit the output document data to the terminal device via the communication interface.

2. The system according to claim 1, wherein the circuitry is configured to apply a machine learning model to at least one of the text data and interaction data received from the terminal device to estimate an affective state value, and to adjust at least one of a tone parameter of the first prompt sentence and an expression parameter of the draft body text based on the affective state value.

3. The system according to claim 2, wherein the circuitry is configured to generate a fourth prompt sentence encoding the draft body text and the affective state value, supply the fourth prompt sentence to the generative neural network model to obtain tone-adjusted body text, and substitute the tone-adjusted body text for the draft body text in the composite document structure.

4. The system according to claim 3, wherein the text data comprises content for a class newsletter, the information units comprise at least event-related units, belonging-related units, and caution-related units, and the affective state value represents at least one of an emotional state and an intent level of a user who is a teacher or educational staff member.

5. The system according to claim 4, wherein the circuitry is configured to identify caution-related units having importance values exceeding a threshold value, and to assign a visual emphasis attribute to sections of the composite document structure corresponding to the identified caution-related units.

6. The system according to claim 1, wherein the circuitry is configured to apply a sentence importance scoring algorithm to each information unit by computing a weighted combination of a content relevance score, a positional weight, and a frequency metric, and to rank the information units by the quantified importance values prior to classifying the information units.

7. The system according to claim 6, wherein the circuitry is configured to partition the ranked information units into a plurality of section categories based on category labels assigned during classification, and to map each section category to a corresponding section template in the predefined document format to generate the section structure.

8. The system according to claim 7, wherein the circuitry is configured to generate the first prompt sentence by encoding the section structure, the heading structure, and a word count constraint as labeled sections, and to receive the draft body text from the generative neural network model as a structured document comprising section headings and body paragraphs conforming to the section structure.

9. The system according to claim 8, wherein the circuitry is configured to validate the draft body text against the section structure by verifying that each required section heading is present and that body paragraph word counts satisfy the word count constraint, and to regenerate the first prompt sentence with adjusted constraints if validation fails.

10. The system according to claim 1, wherein the image recognition algorithm comprises a convolutional neural network configured to extract visual feature vectors from the candidate image data, and wherein the image attribute data comprises at least a scene category label, a dominant color value, and a composition score for each candidate image.

11. The system according to claim 10, wherein the circuitry is configured to compute an image relevance score for each candidate image by comparing the scene category label with section category labels in the structured data, and to filter the candidate images to retain only images having image relevance scores exceeding a threshold value prior to generating the third prompt sentence.

12. The system according to claim 11, wherein the circuitry is configured to receive the image selection data from the generative neural network model as an ordered list of selected image identifiers with associated placement positions, and to retrieve corresponding image files from the storage device using the image identifiers to populate the image regions specified by the layout data.

13. The system according to claim 1, wherein the circuitry is configured to receive edit instruction data from the terminal device via the communication interface specifying at least one of a section to be modified, replacement text, and a layout adjustment, update the composite document structure based on the edit instruction data, and regenerate the output document data.

14. The system according to claim 13, wherein the circuitry is configured to generate a revision prompt sentence encoding the edit instruction data and the affected section of the draft body text, supply the revision prompt sentence to the generative neural network model to obtain revised body text for the affected section, and update the composite document structure with the revised body text.

15. The system according to claim 14, wherein the circuitry is configured to store a version record of the composite document structure in the storage device prior to applying the edit instruction data, and to restore the composite document structure from the version record in response to a revert instruction received from the terminal device.

16. The system according to claim 1, wherein the circuitry is configured to retrieve past document records from the storage device associated with a user identifier, extract structural preference patterns from the past document records, and incorporate the structural preference patterns as an additional labeled section in the first prompt sentence to condition the generative neural network model toward outputs consistent with previously accepted document structures.

17. The system according to claim 16, wherein the circuitry is configured to generate a preview rendering of the output document data and transmit the preview rendering to the terminal device for display, receive approval data or revision data from the terminal device in response to the preview rendering, and finalize or revise the output document data based on the received data.

18. A system comprising:
circuitry configured to:
receive, via a communication interface coupled to a packet-switched network, text data from a terminal device, apply a sentence importance scoring algorithm to extract a plurality of information units, assign quantified importance values and relevance values to each information unit, and classify the information units into section categories to generate structured data;
reconstruct the structured data into a section structure conforming to a predefined document format, apply a machine learning model to at least one of the text data and interaction data to estimate an affective state value, generate a first prompt sentence encoding the section structure and a tone parameter derived from the affective state value, and supply the first prompt sentence to a generative neural network model to obtain draft body text;
generate a second prompt sentence encoding the draft body text and layout constraint parameters, supply the second prompt sentence to the generative neural network model to obtain layout data, and apply a layout template to the layout data to generate a composite document structure;
apply a convolutional neural network to candidate image data to extract visual feature vectors and generate image attribute data, compute image relevance scores by comparing scene category labels in the image attribute data with section category labels in the structured data, generate a third prompt sentence encoding filtered candidate images and document context data, supply the third prompt sentence to the generative neural network model to obtain image selection data, and insert selected images into the composite document structure; and
generate output document data from the composite document structure and transmit the output document data to the terminal device via the communication interface.

19. The system according to claim 18, wherein the circuitry is configured to receive edit instruction data from the terminal device specifying at least one of a section to be modified and replacement text, generate a revision prompt sentence encoding the edit instruction data and the affected section, supply the revision prompt sentence to the generative neural network model to obtain revised body text, update the composite document structure with the revised body text, and retransmit updated output document data to the terminal device.

20. A method comprising:
receiving, via a communication interface coupled to a packet-switched network, text data from a terminal device, and applying a computational analysis algorithm to the text data to extract a plurality of information units and assign quantified importance values and relevance values to each information unit;
classifying the information units based on the quantified importance values and relevance values to generate structured data, and algorithmically reconstructing the structured data into a section structure and heading structure conforming to a predefined document format;
generating a first prompt sentence encoding the structured data and supplying the first prompt sentence to a generative neural network model to obtain draft body text, and generating a second prompt sentence encoding the draft body text and layout constraint parameters to obtain layout data specifying a visual arrangement of textual regions and image regions;
applying a layout template to the layout data to generate a composite document structure, applying an image recognition algorithm to candidate image data to extract image attribute data, generating a third prompt sentence encoding the image attribute data and document context data, supplying the third prompt sentence to the generative neural network model to obtain image selection data, and inserting selected images into the composite document structure at positions specified by the layout data; and
generating output document data from the composite document structure and transmitting the output document data to the terminal device via the communication interface.
